(19) United States
(12) Patent Application Publication
(10) Pub. No.: US 2025/0056500 A1
(43) Pub. Date: Feb. 13, 2025

(54) PAGING RECEPTION AND TRANSMISSION

(71) Applicant: Samsung Electronics Co., Ltd., Suwon-si (KR)

(72) Inventor: Anil Agiwal, Allen, TX (US)

(21) Appl. No.: 18/784,703

(22) Filed: Jul. 25, 2024

Related U.S. Application Data
(60) Provisional application No. 63/531,725, filed on Aug. 9, 2023.

(51) Int. Cl. H04W 68/02; H04W 24/08; H04W 52/02; H04W 72/231

(52) U.S. Cl. CPC H04W 68/02; H04W 24/08; H04W 52/0235; H04W 72/231

(57) ABSTRACT

The user equipment (UE) includes a transceiver configured to receive information indicating a paging occasion, from a plurality of paging occasions, for receiving paging. The UE further includes a processor operably coupled to the transceiver. The processor is configured to determine the paging occasion for receiving paging based on the information. The transceiver is further configured to monitor the determined paging occasion for receiving paging.

### CROSS-REFERENCE TO RELATED APPLICATION(S) AND CLAIM OF PRIORITY

This application claims priority under 35 U.S.C. § 119 (e) to U.S. Provisional Patent Application No. 63/531,725 filed on Aug. 9, 2023. The above-identified provisional patent application is hereby incorporated by reference in its entirety.

### TECHNICAL FIELD

This disclosure relates generally to wireless networks. More specifically, this disclosure relates to paging reception and transmission.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure provides apparatuses and methods for paging reception and transmission.

In one embodiment, a user equipment (UE) is provided. The UE includes a transceiver configured to receive information indicating a paging occasion, from a plurality of paging occasions, for receiving paging. The UE further includes a processor operably coupled to the transceiver. The processor is configured to determine the paging occasion for receiving paging based on the information. The transceiver is further configured to monitor the determined paging occasion for receiving paging.

In another embodiment, a base station (BS) is provided. The BS includes a transceiver configured to transmit information indicating a paging occasion, from a plurality of paging occasions, for receiving paging. The BS further includes a processor operably coupled to the transceiver. The processor is configured to determine a paging occasion for transmitting paging based on the information. The transceiver is further configured to transmit the paging in the paging occasion for receiving paging.

In yet another embodiment, a method of operating a UE is provided. The method includes receiving information indicating a paging occasion, from a plurality of paging occasions, for receiving paging, and determining the paging occasion for receiving paging based on the information. The method further includes monitoring the determined paging occasion for receiving paging.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4 illustrates an example of monitoring for paging based on an LP WUS according to embodiments of the present disclosure;

FIG. 5 illustrates an example of paging transmission and reception according to embodiments of the present disclosure;

FIG. 6 illustrates an example UE operation for paging reception according to embodiments of the present disclosure;

FIG. 7 illustrates an example UE operation for determining a paging occasion or the PDCCH monitoring occasions of a paging occasion according to embodiments of the present disclosure;

FIG. 8 illustrates another example of paging transmission and reception according to embodiments of the present disclosure;

FIG. 9 illustrates another example UE operation for paging reception according to embodiments of the present disclosure;

FIG. 10 illustrates an example UE operation for determining a PEI-O or the PDCCH monitoring occasions of a PEI-O according to embodiments of the present disclosure;

FIG. 11 illustrates another example UE operation for determining a paging occasion or the PDCCH monitoring occasions of a paging occasion according to embodiments of the present disclosure;

FIG. 12 illustrates another example of paging transmission and reception according to embodiments of the present disclosure;

FIG. 13 illustrates another example UE operation for paging reception according to embodiments of the present disclosure; and

FIG. 14 illustrates an example method for paging reception according to embodiments of the present disclosure.

### DETAILED DESCRIPTION

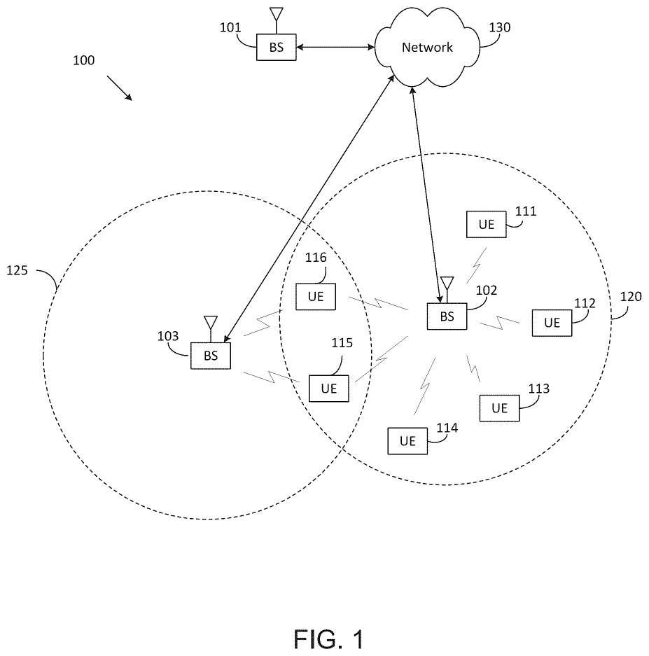

FIGS. 1 through 14, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for paging reception and transmission. In certain embodiments, one or more of the gNBs 101-103 includes circuitry, programing, or a combination thereof, to support paging reception and transmission in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

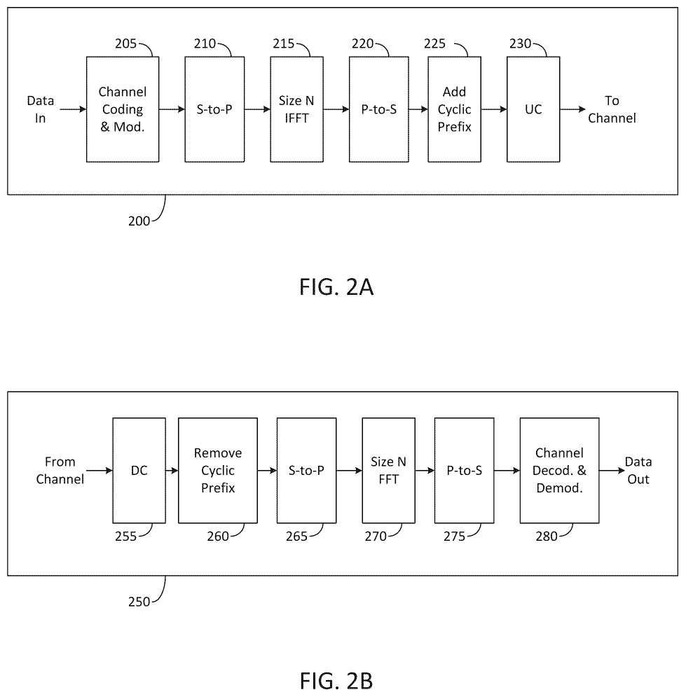

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support paging reception and transmission as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

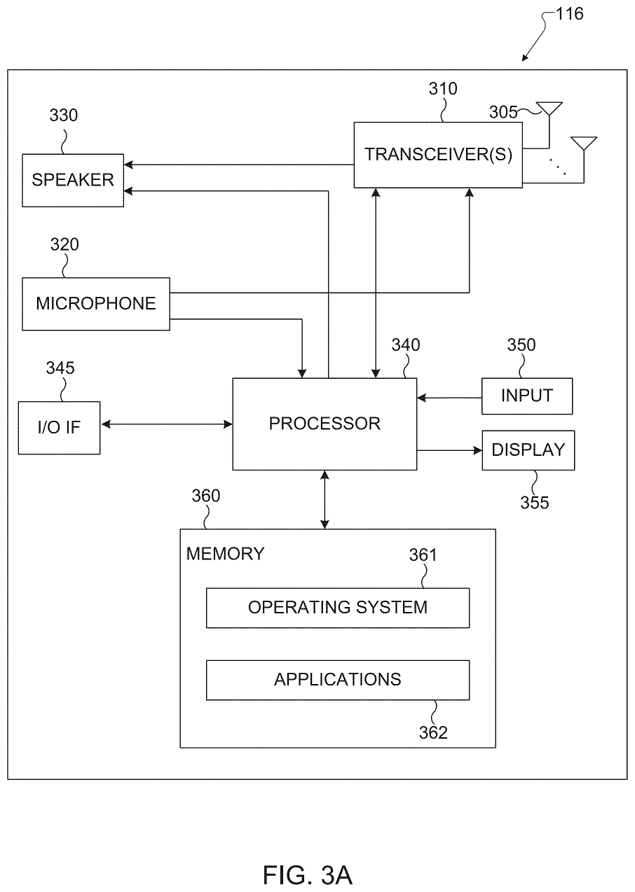

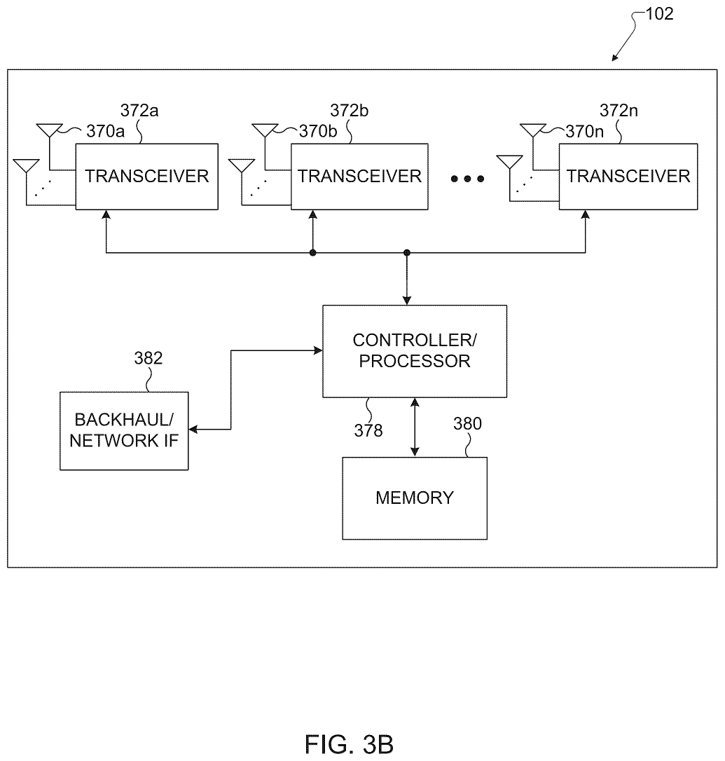

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for paging reception and transmission as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support paging reception and transmission as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

The next generation wireless communication system (e.g., 5G) supports not only lower frequency bands but also higher frequency (mm Wave) bands, e.g., 10 GHz to 100 GHz bands, so as to accomplish higher data rates. To mitigate propagation loss of the radio waves and increase the transmission distance, beamforming, massive Multiple-Input Multiple-Output (MIMO), Full Dimensional MIMO (FD-MIMO), array antenna, analog beam forming, and large-scale antenna techniques are being considered in the design of the fifth-generation wireless communication system. In addition, the fifth-generation wireless communication system is expected to address different use cases having quite different requirements in terms of data rate, latency, reliability, mobility etc. However, it is expected that the design of the air-interface of the fifth-generation wireless communication system would be flexible enough to serve UEs having quite different capabilities depending on the use case and market segment the UE caters to service the end customer. A few example use cases of the fifth-generation wireless communication system wireless system are expected to address are enhanced Mobile Broadband (eMBB), massive Machine Type Communication (m-MTC), ultra-reliable low latency communication (URLL) etc. The eMBB requirements like tens of Gbps data rate, low latency, high mobility, etc. address the market segment representing the conventional wireless broadband subscribers needing internet connectivity everywhere, all the time and on the go. The m-MTC requirements like very high connection density, infrequent data transmission, very long battery life, low mobility, etc. address the market segment representing the Internet of Things (IoT)/Internet of Everything (IoE) envisioning connectivity of billions of devices. The URLL requirements like very low latency, very high reliability and variable mobility, etc. address the market segment representing industrial automation applications, and vehicle-to-vehicle/vehicle-to-infrastructure communication foreseen as one of the enablers for autonomous cars.

In the next generation wireless communication system (e.g., 5G, beyond 5G, 6G) operating in higher frequency (e.g., mmWave, terahertz) bands, UEs and gNBs communicate with each other using Beamforming. Beamforming techniques are used to mitigate the propagation path losses and to increase the propagation distance for communication at higher frequency bands. Beamforming enhances the transmission and reception performance using a high-gain antenna. Beamforming can be classified into Transmission (TX) beamforming performed in a transmitting end and reception (RX) beamforming performed in a receiving end. In general, TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of TX beamforming results in an increase in the directivity of a signal, thereby increasing a propagation distance. Further, since the signal is almost not transmitted in a direction other than a directivity direction, a signal interference acting on another receiving end is significantly decreased. The receiving end can perform beamforming on a RX signal by using a RX antenna array. RX beamforming increases the RX signal strength transmitted in a specific direction by allowing propagation to be concentrated in a specific direction, and excludes a signal transmitted in a direction other than the specific direction from the RX signal, thereby providing an effect of blocking an interference signal. By using beamforming techniques, a transmitter can generate a plurality of transmit beam patterns of different directions. Each of these transmit beam patterns can be also referred as a transmit (TX) beam. Wireless communication system operating at high frequency use a plurality of narrow TX beams to transmit signals in the cell as each narrow TX beam provides coverage to a part of the cell. The narrower the TX beam, the higher the antenna gain and hence the larger the propagation distance of a signal transmitted using beamforming. A receiver can also generate a plurality of receive (RX) beam patterns of different directions. Each of these receive patterns can be also referred as a receive (RX) beam.

The next generation wireless communication system (e.g., 5G, beyond 5G, 6G) supports standalone modes of operation as well dual connectivity (DC). In DC a multiple Rx/Tx UE may be configured to utilize resources provided by two different nodes (or NBs) connected via non-ideal backhaul. One node acts as the Master Node (MN) and the other as the Secondary Node (SN). The MN and SN are connected via a network interface and at least the MN is connected to the core network. NR also supports Multi-RAT Dual Connectivity (MR-DC) operation whereby a UE in an RRC_CONNECTED state is configured to utilize radio resources provided by two distinct schedulers, located in two different nodes connected via a non-ideal backhaul and providing either E-UTRA (i.e., if the node is an ng-eNB) or NR access (i.e., if the node is a gNB). In NR for a UE in an RRC_CONNECTED state not configured with CA/DC there is only one serving cell comprising the primary cell. For a UE in an RRC_CONNECTED state configured with CA/DC the term ‘serving cells’ is used to denote the set of cells comprising the Special Cell(s) and all secondary cells. In NR the term Master Cell Group (MCG) refers to a group of serving cells associated with the Master Node, comprising the PCell and optionally one or more SCells. In NR the term Secondary Cell Group (SCG) refers to a group of serving cells associated with the Secondary Node, comprising the PSCell and optionally one or more SCells. In NR, PCell (primary cell) refers to a serving cell in a MCG, operating on the primary frequency, in which the UE either performs the initial connection establishment procedure or initiates the connection re-establishment procedure. In NR for a UE configured with CA, an Scell is a cell providing additional radio resources on top of the Special Cell. Primary SCG Cell (PSCell) refers to a serving cell in the SCG in which the UE performs random access when performing the Reconfiguration with Sync procedure. For Dual Connectivity operation the term SpCell (i.e., Special Cell) refers to the PCell of the MCG or the PSCell of the SCG, otherwise the term Special Cell refers to the PCell.

In the next generation wireless communication system (e.g., 5G, beyond 5G, 6G), a node B (gNB) or base station in cell broadcast Synchronization Signal and PBCH block (SSB) comprises primary and secondary synchronization signals (PSS, SSS) and system information. System information includes common parameters needed to communicate in a cell. In the next generation wireless communication system (also referred as next generation radio or NR), System Information (SI) is divided into the master information block (MIB) and a number of system information blocks (SIBs), where the MIB is transmitted on the BCH with a periodicity of 80 ms and repetitions are made within 80 ms and the MIB includes parameters that are needed to acquire a SIB1 from the cell. The SIB1 is transmitted on the DL-SCH with a periodicity of 160 ms and variable transmission repetition. The default transmission repetition periodicity of SIB1 is 20 ms but the actual transmission repetition periodicity is up to network implementation. For SSB and CORESET multiplexing pattern 1, the SIB1 repetition transmission period is 20 ms. For SSB and CORESET multiplexing pattern 2/3, the SIB1 transmission repetition period is the same as the SSB period. SIB1 includes information regarding the availability and scheduling (e.g., mapping of SIBs to an SI message, periodicity, SI-window size) of other SIBs with an indication whether one or more SIBs are only provided on-demand, and, in that case, the configuration needed by the UE to perform the SI request. SIB1 is a cell-specific SIB; SIBs other than SIB1 and posSIBs are carried in SystemInformation (SI) messages, which are transmitted on the DL-SCH. Only SIBs or posSIBs having the same periodicity are mapped to the same SI message. SIBs and posSIBs are mapped to different SI messages. Each SI message is transmitted within a periodically occurring time domain windows (referred to as SI-windows with the same length for all SI messages). Each SI message is associated with an SI-window and the SI-windows of different SI messages do not overlap. That is, within one SI-window only the corresponding SI message is transmitted. An SI message may be transmitted a number of times within the SI-window. Any SIB or posSIB except SIB1 can be configured to be cell specific or area specific, using an indication in SIB1. The cell specific SIB is applicable only within a cell that provides the SIB while the area specific SIB is applicable within an area referred to as an SI area, which comprises one or several cells and is identified by systemInformationAreaID. The mapping of SIBs to SI messages is configured in schedulingInfoList, while the mapping of posSIBs to SI messages is configured in pos-SchedulingInfoList. Each SIB is contained in a single SI message and each SIB and posSIB is contained at most once in that SI message. For a UE in an RRC_CONNECTED state, the network can provide system information through dedicated signaling using the RRCReconfiguration message, e.g., if the UE has an active BWP with no common search space configured to monitor system information, paging, or upon request from the UE. In the RRC_CONNECTED state, the UE acquires the required SIB(s) from the PCell. For PSCell and SCells, the network provides the required SI by dedicated signaling, i.e., within an RRCReconfiguration message. Nevertheless, the UE acquires the MIB of the PSCell to get system frame number (SFN) timing of the SCG (which may be different from the MCG). Upon a change of relevant SI for an SCell, the network releases and adds the concerned SCell. For a PSCell, the required SI is changed with Reconfiguration with Sync.

In the next wireless communication system (e.g., 5G, beyond 5G, 6G), random access (RA) is supported. Random access (RA) is used to achieve uplink (UL) time synchronization. RA is used during initial access, handover, radio resource control (RRC) connection re-establishment procedure, scheduling request transmission, secondary cell group (SCG) addition/modification, beam failure recovery and data or control information transmission in UL by non-synchronized UEs in a RRC CONNECTED state. Several types of random-access procedure are supported such as contention based random access and contention free random access, and each of these can be one of 2 step or 4 step random access.

In the next generation wireless communication system (e.g., 5G, beyond 5G, 6G), a Physical Downlink Control Channel (PDCCH) is used to schedule DL transmissions on a PDSCH and UL transmissions on a PUSCH, where the Downlink Control Information (DCI) on the PDCCH includes downlink assignments containing at least modulation and coding format, resource allocation, and hybrid-ARQ information related to DL-SCH; Uplink scheduling grants containing at least modulation and coding format, resource allocation, and hybrid-ARQ information related to UL-SCH. In addition to scheduling, the PDCCH can be used to for activation and deactivation of configured PUSCH transmission with configured grant; activation and deactivation of PDSCH semi-persistent transmission; notifying one or more UEs of the slot format; notifying one or more UEs of the PRB(s) and OFDM symbol(s) where the UE may assume no transmission is intended for the UE; transmission of TPC commands for PUCCH and PUSCH; transmission of one or more TPC commands for SRS transmissions by one or more UEs; switching a UE's active bandwidth part; and initiating a random access procedure. A UE monitors a set of PDCCH candidates in the configured monitoring occasions in one or more configured Control REsource SETs (CORESETs) according to the corresponding search space configurations. A CORESET comprises a set of PRBs with a time duration of 1 to 3 OFDM symbols. The resource units Resource Element Groups (REGs) and Control Channel Elements (CCEs) are defined within a CORESET with each CCE comprising a set of REGs. Control channels are formed by aggregation of CCE. Different code rates for the control channels are realized by aggregating a different number of CCE. Interleaved and non-interleaved CCE-to-REG mapping is supported in a CORESET. Polar coding is used for the PDCCH. Each resource element group carrying the PDCCH carries its own DMRS. QPSK modulation is used for the PDCCH.

In the next generation wireless communication system (e.g., 5G, beyond 5G, 6G), a list of search space configurations is signaled by the gNB for each configured BWP of the serving cell, wherein each search configuration is uniquely identified by a search space identifier. The search space identifier is unique amongst the BWPs of a serving cell. An identifier of a search space configuration to be used for a specific purpose such as paging reception, SI reception, or random access response reception is explicitly signaled by the gNB for each configured BWP. In NR, a search space configuration comprises the parameters Monitoring-periodicity-PDCCH-slot, Monitoring-offset-PDCCH-slot, Monitoring-symbols-PDCCH-within-slot and duration. A UE determines the PDCCH monitoring occasion(s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are in slots ‘x’ to x+duration where the slot with number ‘x’ in a radio frame with number ‘y’ satisfies the equation below:

(y*(number of slots in a radio frame)+x−Monitoring-offset-PDCCH-slot)mod(Monitoring-periodicity-PDCCH-slot)=0.

The starting symbol of a PDCCH monitoring occasion in each slot having a PDCCH monitoring occasion is given by Monitoring-symbols-PDCCH-within-slot. The length (in symbols) of a PDCCH monitoring occasion is given in the CORESET associated with the search space. The search space configuration includes the identifier of the CORESET configuration associated with it. A list of CORESET configurations are signaled by the gNB for each configured BWP of the serving cell, wherein each CORESET configuration is uniquely identified by a CORESET identifier. The CORESET identifier is unique amongst the BWPs of a serving cell. Note that each radio frame is of 10 ms duration. Each radio frame is identified by a radio frame number or system frame number. Each radio frame comprises several slots, wherein the number of slots in a radio frame and duration of slots depends on sub carrier spacing. The number of slots in a radio frame and duration of slots for each supported SCS is pre-defined in NR. Each coreset configuration is associated with a list of TCI (Transmission configuration indicator) states. One DL RS ID (SSB or CSI RS) is configured per TCI state. The list of TCI states corresponding to a CORESET configuration is signaled by the gNB via RRC signaling. One of the TCI states in a TCI state list is activated and indicated to the UE by the gNB. The TCI state indicates the DL TX beam (DL TX beam is QCLed with SSB/CSI RS of TCI state) used by the gNB for transmission of a PDCCH in the PDCCH monitoring occasions of a search space.

In the next generation wireless communication system (e.g., 5G, beyond 5G, 6G), bandwidth adaptation (BA) is supported. With BA, the receive and transmit bandwidth of a UE need not be as large as the bandwidth of the cell and can be adjusted: the width can be ordered to change (e.g., to shrink during period of low activity to save power); the location can move in the frequency domain (e.g., to increase scheduling flexibility); and the subcarrier spacing can be ordered to change (e.g., to allow different services). A subset of the total cell bandwidth of a cell is referred to as a Bandwidth Part (BWP). BA is achieved by configuring an RRC connected UE with BWP(s) and telling the UE which of the configured BWPs is currently the active one. When BA is configured, the UE only has to monitor PDCCH on the one active BWP i.e., the UE does not have to monitor PDCCH on the entire DL frequency of the serving cell. In an RRC connected state, the UE is configured with one or more DL and UL BWPs, for each configured Serving Cell (i.e., PCell or SCell). For an activated Serving Cell, there is one active UL and DL BWP at any point in time. BWP switching for a Serving Cell is used to activate an inactive BWP and deactivate an active BWP at a particular time. BWP switching is controlled by the PDCCH indicating a downlink assignment or an uplink grant, by the bwp-InactivityTimer, by RRC signaling, or by the MAC entity itself upon initiation of a Random-Access procedure. Upon addition of an SpCell or activation of an SCell, the DL BWP and UL BWP indicated by firstActiveDownlinkBWP-Id and firstActiveUplinkBWP-Id respectively is active without receiving a PDCCH indicating a downlink assignment or an uplink grant. The active BWP for a Serving Cell is indicated by either RRC or PDCCH. For unpaired spectrum, a DL BWP is paired with a UL BWP, and BWP switching is common for both UL and DL. Upon expiry of the BWP inactivity timer, the UE switches from the active DL BWP to the default DL BWP or initial DL BWP (if a default DL BWP is not configured).

In the next generation wireless communication system (e.g., 5G, beyond 5G, 6G), a UE can be in one of the following RRC states: RRC IDLE, RRC INACTIVE and RRC CONNECTED. Paging allows the network to reach UEs in the RRC_IDLE and in the RRC_INACTIVE state through Paging messages, and to notify UEs in the RRC_IDLE, RRC_INACTIVE and RRC_CONNECTED state of system information change and ETWS (Earthquake and Tsunami Warning System)/CMAS (Commercial Mobile Alert System) indications through Short Messages. Both Paging messages and Short Messages are addressed with P-RNTI on PDCCH, but while the former is sent on a PCCH logical channel (a TB carrying the paging message is transmitted over the PDSCH [Physical downlink shared channel]), the latter is sent over the PDCCH directly.

While in the RRC_IDLE state the UE monitors the paging channels for CN-initiated paging. While in the RRC_INACTIVE state the UE monitors paging channels for RAN-initiated paging and CN-initiated paging. A UE need not monitor paging channels continuously though. Paging DRX is defined where the UE in the RRC_IDLE or RRC_INACTIVE state is only required to monitor paging channels during one Paging Occasion (PO) per DRX cycle.

A PO is a set of PDCCH monitoring occasions and can comprise multiple time slots (e.g., subframes or OFDM symbols) where paging DCI (i.e., PDCCH addressed to P-RNTI) can be sent. One Paging Frame (PF) is one Radio Frame and may contain one or multiple PO(s) or a starting point of a PO. A PO associated with a PF may start in the PF or after the PF.

In multi-beam operations, the UE assumes that the same paging message and the same Short Message are repeated in all transmitted beams and thus the selection of the beam(s) for the reception of the paging message and Short Message is up to UE implementation. The paging message is the same for both RAN initiated paging and CN initiated paging. The UE initiates an RRC Connection Resume procedure upon receiving a RAN initiated paging. If the UE receives a CN initiated paging in the RRC_INACTIVE state, the UE moves to the RRC_IDLE state and informs the NAS.

The PF and PO for paging are determined (by the UE and base station e.g., gNB) by the following formulae:

SFN for the PF is determined by:

(SFN+PF_offset)mod T=(T div N)*(UE_ID mod N)

Index (i_s), indicating the index of the PO is determined by:

i_s=floor(UE_ID/N)mod Ns

The PDCCH monitoring occasions for paging are determined according to pagingSearchSpace and firstPDCCH-MonitoringOccasionOfPO and nrofPDCCH-MonitoringOccasionPerSSB-InPO if configured. When SearchSpaceId=0 is configured for pagingSearchSpace, the PDCCH monitoring occasions for paging are the same as for RMSI.

When SearchSpaceId=0 is configured for pagingSearchSpace, Ns is either 1 or 2. For Ns=1, there is only one PO which starts from the first PDCCH monitoring occasion for paging in the PF. For Ns=2, the PO is either in the first half frame (i_s=0) or the second half frame (i_s=1) of the PF.

When SearchSpaceId other than 0 is configured for pagingSearchSpace, the UE monitors the (i_s+1)^{th} PO. A PO is a set of ‘S*X’ consecutive PDCCH monitoring occasions where ‘S’ is the number of actual transmitted SSBs determined according to ssb-PositionsInBurst in SIB1 and X is the nrofPDCCH-MonitoringOccasionPerSSB-InPO if configured or is equal to 1 otherwise. The [x*S+K]^{th} PDCCH monitoring occasion for paging in the PO corresponds to the Kth transmitted SSB, where x=0,1, . . . , X−1, K=1, 2, . . . , S. The PDCCH monitoring occasions for paging which do not overlap with UL symbols (determined according to tdd-UL-DL-ConfigurationCommon) are sequentially numbered from zero starting from the first PDCCH monitoring occasion for paging in the PF. When firstPDCCH-MonitoringOccasionOfPO is present, the starting PDCCH monitoring occasion number of (i_s+1)^{th} PO is the (i_s+1)^{th} value of the firstPDCCH-MonitoringOccasionOfPO parameter; otherwise, it is equal to i_s*S*X. If X>1, when the UE detects a PDCCH transmission addressed to P-RNTI within its PO, the UE is not required to monitor the subsequent PDCCH monitoring occasions for this PO.

The following parameters are used for the calculation of PF and i_s above:
T: DRX cycle of the UE.
N: number of total paging frames in T; N is one of T, T/2, T/4, T/8, T/16
Ns: number of paging occasions for a PF; NS is one of 1, 2, 4
PF_offset: offset used for PF determination
UE_ID:
If the UE operates in eDRX:
   5G-S-TMSI mod 4096
otherwise:
   5G-S-TMSI mod 1024

The parameters Ns, nAndPagingFrameOffset, nrofPDCCH-MonitoringOccasionPerSSB-InPO, and the length of default DRX Cycle are signaled in SIB1. The values of N and PF_offset are derived from the parameter nAndPagingFrameOffset. The parameter firstPDCCH-MonitoringOccasionOfPO is signaled in SIB1 for paging in the BWP configured by initialDownlinkBWP. For paging in a DL BWP other than the BWP configured by initialDownlinkBWP, the parameter first-PDCCH-MonitoringOccasionOfPO is signaled in the corresponding BWP configuration. If the UE has no 5G-S-TMSI, for instance when the UE has not yet registered onto the network, the UE shall use as default identity UE_ID=0 in the PF and i_s formulas above.

In order to reduce UE power consumption due to false paging alarms, the group of UEs monitoring the same PO can be further divided into multiple subgroups. With subgrouping, a UE shall monitor the PDCCH in its PO for paging if the subgroup to which the UE belongs is paged as indicated via an associated PEI (Paging Early Indication). If a UE cannot find its subgroup ID with the PEI configurations in a cell or if the UE is unable to monitor the associated PEI occasion corresponding to its PO, it shall monitor the paging in its PO.

Paging with CN assigned subgrouping is used in cells which support CN assigned subgrouping. A UE supporting CN assigned subgrouping in the RRC_IDLE or RRC_INACTIVE state can be assigned a subgroup ID (between 0 to 7) by an AMF through NAS signaling.

If a UE is not configured with a CN assigned subgroup ID, or if a UE configured with a CN assigned subgroup ID is in a cell supporting only UE_ID based subgrouping, the subgroup ID of the UE is determined by the formula below:

SubgroupID=(floor(UE_ID/(N*Ns))mod subgroupsNumForUEID)+(subgroupsNumPerPO−subgroupsNumForUEID),

where:
N: number of total paging frames in T, which is the DRX cycle of the RRC_IDLE state
Ns: number of paging occasions for a PF
UE_ID: 5G-S-TMSI mod X, where X is 32768, if eDRX is applied; otherwise, X is 8192 subgroupsNumForUEID: number of subgroups for UE_ID based subgrouping in a PO, which is broadcasted in system information.

The UE monitors one PEI occasion per DRX cycle. A PEI occasion (PEI-O) is a set of PDCCH monitoring occasions (MOs) and can comprise multiple time slots (e.g., subframes or OFDM symbols) where PEI can be sent. In multi-beam operations, the UE assumes that the same PEI is repeated in all transmitted beams and thus the selection of the beam(s) for the reception of the PEI is up to UE implementation. The time location of PEI-O for the UE's PO is determined by a reference point and an offset:
The reference point is the start of a reference frame determined by a frame-level offset from the start of the first PF of the PF(s) associated with the PEI-O, provided by pei-FrameOffset in SIB1. The first PF of the PFs associated with the PEI-O is provided by (SFN for PF)-floor (i_{PO}/N_{S})*T/N, where iₚₒ=((UE_IDmodN)·N_{S}+i_s)modN_{PO}^{PEI} is a paging occasion index, and N_{PO}^{PEI} is signaled by po-NumPerPEI.
The offset is a symbol-level offset from the reference point to the start of the first PDCCH MO of this PEI-O, provided by firstPDCCH-MonitoringOccasionOfPEI-O in SIB1.

Currently, UEs wake up once per DRX cycle, which dominates the power consumption in periods with no signaling or data traffic. Power consumption could be dramatically reduced by using a wake-up signal to trigger the main radio (MR) and a separate low power wakeup receiver (LR), which has the ability to monitor wake-up signal, with ultra-low power consumption. The low power wakeup receiver (LR) is expected to consume 1/100 of power consumed by the MR. The MR works for data transmission and reception, which can be turned off or set to deep sleep unless it is turned on. It is expected that a UE in the RRC_IDLE or RRC_INACTIVE state monitors for Low power wakeup signal (LP WUS) using the LR if the UE and camped cell supports LP WUS. The gNB transmits a low power wakeup signal when it needs to send RAN paging or CN paging to the UE or SI/emergency notifications to the UE. If the LP WUS is received:
Option 1: The UE monitors for a PEI in its PEI-O. The UE monitors for the PEI (using MR) and/or subsequently UE monitors its PO in its PF (using MR) and receives a paging message (if scheduled by the monitored PO) if the PEI indicates paging for a UE/UE specific paging subgroup. The UE determines its PEI-O, PF/PO as described earlier.
Option 2: The UE monitors its PO (e.g., if the cell/UE does not support PEI) in its PF. After PO monitoring, the UE receives a PDSCH (if scheduled by DCI in the monitored PO) including a paging message. The UE determines its PF/PO as in legacy.

The payload of the LP WUS may include one or more of the following:
information on which user(s) is/are targeted by the LP-WUS:
   e.g., UE-group, -subgroup or -ID
cell information
SI change and ETWS/CMAS information
tracking area information, RAN area information

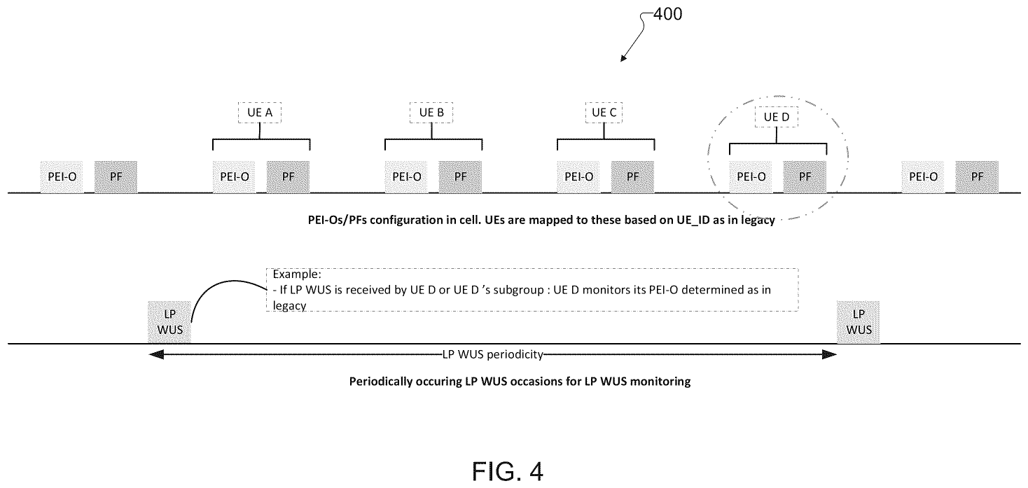

FIG. 4 illustrates an example 400 of monitoring for paging based on a LP WUS according to embodiments of the present disclosure. The embodiment of monitoring for paging of FIG. 4 is for illustration only. Different embodiments of monitoring for paging based on a LP WUS could be used without departing from the scope of this disclosure.

In the example of FIG. 4, an LP WUS occasion occurs periodically. There can be several PEI-Os/PFs between the two LP WUS occasions. If the LP WUS is received by the UE and the LP WUS indicates for the UE or UE's subgroup to wakeup/monitor a PEI-O/PO/PF, the UE monitors its PEI-O/PF/PO where the PEI-O/PF/PO are determined as explained earlier. There are several issues with this approach:
Delay in delivering paging as the UE's PEI-O/PF can be far away from the LP WUS occasion. As shown in FIG. 4, if an LP WUS is received by UE-D, UE-D monitors its PEI-O determined with respect to its PF, which is further away from other PEI-Os located after the LP WUS occasion. To reduce the delay, the LP WUS occasions can be configured at a short interval (e.g., one LP WUS occasion for every configured PEI-O), however this leads to increased LP WUS overhead and network energy consumption.
Even if paging can be done using one PF/PO, considering the number of UEs to be paged, the network still has to send paging in several PFs/POs as UEs to be paged are mapped to different PFs/POs. As shown in FIG. 4, if there is paging for UE A, UE B, UE C and UE D, the network has to send paging in four different PEI-Os/POs. The network cannot send the paging together in one PEI-O/PO. The Network has to send 4 PDCCHs in each of PEI-0, 4 PDCCHs in each of PO and 4 paging messages each scheduled by a separate PDCCH.
For paging, several signals/channels (LP WUS, PEI, paging DCI in PO and PDSCH) a transmitted to support legacy UEs. A clean design with reduced signals/channels can be beneficial for reducing network signaling overhead and energy consumption.

The present disclosure provides methods that overcome these issues.

Although FIG. 4 illustrates an example 400 of monitoring for paging based on a LP WUS, various changes may be made to FIG. 4. For example, various changes to the LP WUS periodicity, the number of PEI-Os, etc. could be made according to particular needs.

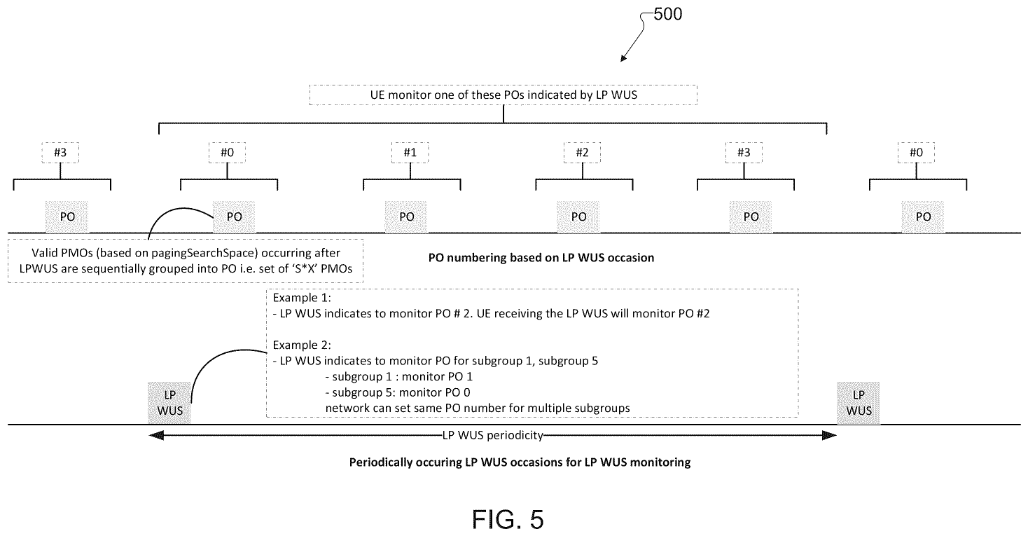

FIG. 5 illustrates an example 500 of paging transmission and reception according to embodiments of the present disclosure. The embodiment of paging transmission and reception of FIG. 5 is for illustration only. Different embodiments of paging transmission and reception could be used without departing from the scope of this disclosure.

In the example of FIG. 5, a UE monitors a time/frequency resource or occasion (e.g., an LP WUS occasion) periodically. The time/frequency resource or occasion or LP WUS occasion may be used interchangeably without departing from the scope of this disclosure. The resource or occasion may comprise of one of more symbols/slots/subframes etc. in the time domain and one or more resource elements or resource blocks in the frequency domain. The valid PDCCH monitoring occasions for paging (determined based on a paging search space, the paging search space is signaled by the gNB e.g., in system information or an RRC message) occurring after the monitored time/frequency resource or occasion (e.g., the LP WUS occasion) (or occurring at an offset after the monitored time/frequency resource or occasion or LP WUS occasion or occurring at an offset after the end of radio frame/slot/subframe of the monitored time/frequency resource or occasion or LP WUS occasion) are sequentially grouped into paging occasions (POs) and numbered. As illustrated in FIG. 5, the valid PDCCH monitoring occasions for paging occurring after the monitored time/frequency resource or occasion or LP WUS occasion are sequentially grouped into paging occasions #0 to #3. Each paging occasion comprises a plurality of consecutive valid PDCCH monitoring occasions for paging. In one embodiment, a plurality of consecutive valid PDCCH monitoring occasions in a paging occasion can be equal to S*X where S is the number of transmitted beams or SSBs or any other reference signal by the gNB in the cell and X is the number of PDCCH monitoring occasions per SSB/transmitted beam/reference signal. S and X are signaled by the gNB in SI or an RRC message. X can be equal to 1 if not configured.

In one embodiment, an LP WUS or LP WUS payload or payload or information received by the UE in the monitored time/frequency resource or occasion or LP WUS occasion indicates to monitor a specific PO. The LP WUS or LP WUS payload or payload or information is transmitted by the gNB in the monitored time/frequency resource or occasion or LP WUS occasion. As illustrated in FIG. 5, the LP WUS or LP WUS payload or payload or information received by the UE in the monitored time/frequency resource or occasion or LP WUS occasion indicates to monitor PO #2. The UE monitors the PO #2. In one embodiment, the UE may use the MR to monitor the indicated paging occasion. The UE may wakeup the MR to monitor the indicated paging occasion. The gNB transmits a PDCCH addressed to a P-RNTI in PO #2. The paging DCI of this PDCCH includes scheduling information for a PDSCH TB, wherein the TB includes a paging message. In one embodiment, the UE may indicate/signal (e.g. in an RRC message) to the gNB its capability to support the operation illustrated in FIG. 5.

In another embodiment, the LP WUS or LP WUS payload or payload or information received in the monitored time/frequency resource or occasion or LP WUS occasion indicates to monitor a specific PO per paging subgroup. As illustrated in FIG. 5, the LP WUS or LP WUS payload or payload or information received in the monitored time/frequency resource or occasion or LP WUS occasion indicates to monitor PO #1 for subgroup 1 and monitor PO #O for subgroup 5. If the UE's subgroup is 1, the UE monitors the paging occasion #1. If the UE's subgroup is 5, the UE monitors the paging occasion #0. In one embodiment, the UE may use the MR to monitor the indicated paging occasion. The UE may wakeup the MR to monitor the indicated paging occasion. The gNB transmits a PDCCH addressed to a P-RNTI in PO #0. The paging DCI of this PDCCH includes scheduling information for a PDSCH TB, wherein the TB includes a paging message for paging UE(s) of subgroup 5. The gNB transmits a PDCCH addressed to a P-RNTI in PO #1. The paging DCI of this PDCCH includes scheduling information for a PDSCH TB wherein the TB includes a paging message for the paging UE(s) of subgroup 1.

Although FIG. 5 illustrates an example 500 of paging transmission and reception, various changes may be made to FIG. 5. For example, various changes to the LP WUS periodicity, the number of POs, etc. could be made according to particular needs.

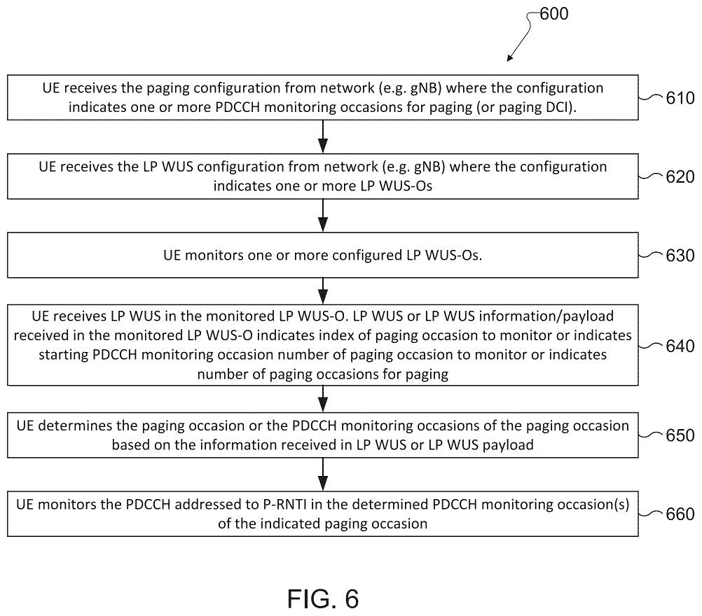

FIG. 6 illustrates an example UE operation for paging reception 600 according to embodiments of the present disclosure. An embodiment of the operation illustrated in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments for a UE operation for paging reception could be used without departing from the scope of this disclosure. In one embodiment, the UE may indicate/signal (e.g. in an RRC message) to the gNB its capability to support the operation illustrated in FIG. 6.

In the example of FIG. 6, the operation begins at step 610. At step 610, a UE, such as UE 116 of FIG. 1, receives the paging configuration from the network (e.g., a gNB) where the configuration indicates one or more PDCCH monitoring occasions for paging (or PDCCH monitoring occasions for paging DCI). The Paging configuration is for the cell or TRP where the UE monitors paging. The cell can be the camped cell, in case the UE is in the RRC IDLE or RRC INACTIVE state. The cell can be the serving cell or PCell or SpCell, in case the UE is in the RRC_CONNECTED state. The paging configuration may be received from the cell where the UE monitors paging or from another cell. The cell can be the camped cell, in case the UE is in the RRC IDLE or RRC INACTIVE state. The cell can be the serving cell or PCell, in case the UE is in the RRC_CONNECTED state. The paging configuration may be received in system information (e.g., in a system information block or SI message). The paging configuration may be received in an RRC message (e.g., in an RRC Reconfiguration message). The Paging configuration may include a parameter ‘pagingSearchSpace’ to indicate one or more PDCCH monitoring occasions for paging (or PDCCH monitoring occasions for paging DCI). The Parameter ‘pagingSearchSpace’ is set to the search space identifier of search space amongst the one or more (common) search spaces configured in the cell and signaled by network. A list of search space configurations can be signaled where each search space configuration is uniquely identified by a search space identifier. Each search space configuration indicates a location of PDCCH monitoring occasions in time and frequency. Using the parameter ‘pagingSearchSpace’ the UE identifies the search space configuration for PDCCH monitoring occasions of paging amongst the list of search space configurations. The Parameter ‘pagingSearchSpace’ can be set to zero. ‘pagingSearchSpace’ set to zero indicates that PDCCH monitoring occasions for paging are the same as PDCCH monitoring occasions for receiving RMSI or SIB1. A Parameter to indicate PDCCH monitoring occasions for receiving RMSI or SIB1 is signaled by the network in a MIB.

At step 620, the UE receives the LP WUS configuration from the network (e.g., the gNB) where the configuration indicates one or more LP WUS-occasions (LP WUS-Os). Each LP WUS-O may comprise one or more monitoring occasions. In one embodiment, the number of monitoring occasions in the LP WUS-O can be equal to S*X where S is the number of transmitted beams or SSBs by the gNB in the cell and X is the number of PDCCH monitoring occasions per SSB/transmitted beam. S and X are signaled by the gNB in SI or an RRC message. X can be equal to 1 if not configured. The LP WUS configuration is for the cell where the UE monitors paging. The cell can be the camped cell, in case the UE is in the RRC IDLE or RRC INACTIVE state. The cell can be the serving cell or PCell or SpCell, in case the UE is in the RRC_CONNECTED state. The LP WUS configuration may be received from the cell where the UE monitors paging or from another cell. The cell can be the camped cell, in case the UE is in the RRC IDLE or RRC INACTIVE state. The cell can be the serving cell or PCell or SpCell, in case the UE is in the RRC_CONNECTED state. The LP WUS configuration may be received in system information (e.g., in a system information block or SI message). The LP WUS configuration may be received in an RRC message (e.g., in an RRC Reconfiguration message). The LP WUS configuration may signal a period and/offset and/or duration where the LP WUS-O(s) occurs periodically with the signaled period, and the first period may start at an offset from SFN 0. A starting time (e.g., slot/symbol), starting frequency resource (e.g., PRB index), number of PRBs and number of slots/symbols of each LP WUS monitoring occasion may also be included in the configuration.

At step 630, the UE monitors one or more configured LP WUS-Os. In one embodiment, the UE may monitor all the configured LP WUS-Os. In one embodiment, the UE may determine to monitor one or more LP WUS-Os from the configured LP WUS-Os based on the UE's identity (e.g., UE ID, S-TMSI, I-RNTI etc.). In one embodiment, the UE may determine to monitor one or more LP WUS-Os from the configured LP WUS-Os based on the UE's subgroup identity. The subgroup identity can be signaled to the UE by the network (e.g., a gNB or AMF or CN) or the subgroup identity can be determined by the UE based on the UE's UE identity. In one embodiment, if there are ‘K’ LP WUS-Os in a DRX cycle, the UE may monitor the jth LP WUS-O where j=UE ID mod K. K is an integer>0. In one embodiment, if there are ‘N’ LP WUS radio frames in a DRX cycle, the UE may monitor the LP WUS-O in a radio frame whose SFN satisfies (SFN+offset) mod T=(T div N)*(UE_ID mod N). The offset can be zero. The offset, N is signaled by the gNB in SI or an RRC message. T is the length of the DRX cycle or LP WUS monitoring cycle. In one embodiment, if there are ‘N’ LP WUS radio frames in a DRX cycle, the UE may monitor the LP WUS-O in a radio frame whose SFN satisfies (SFN+offset) mod T=(UE_ID mod N). The offset can be zero. The offset, N is signaled by the gNB in SI or an RRC message. T is the length of the DRX cycle or LP WUS monitoring cycle. In one embodiment, if there are ‘N’ LP WUS radio frames in a DRX cycle, the UE may monitor the LP WUS occasion in a radio frame whose SFN satisfies SFN mod T=(T div N)*(UE_ID mod N). Nis signaled by the gNB in SI or an RRC message. T is the length of the DRX cycle or LP WUS monitoring cycle. In one embodiment, if there are ‘N’ LP WUS radio frames in a DRX cycle, the UE may monitor the LP WUS occasion in a radio frame whose SFN satisfies SFN mod T=(UE_ID mod N). N is signaled by the gNB in SI or RRC message. T is the length of the DRX cycle or LP WUS monitoring cycle. In one embodiment, if there are ‘N’ LP WUS radio frames in a DRX cycle, the UE may monitor the LP WUS-O in a subframe/slot ‘A’ of SFN ‘B’ which satisfies ((B*number of subframes/slots in a radio frame+A)+offset) mod T=(T div N)*(UE_ID mod N). The offset can be zero. The offset, N is signaled by the gNB in SI or an RRC message. T is the length of the DRX cycle or LP WUS monitoring cycle. In one embodiment, if there are ‘N’ LP WUS radio frames in a DRX cycle, the UE may monitor the LP WUS-O in a subframe/slot ‘A’ of SFN ‘B’ which satisfies ([B*number of subframes/slots in a radio frame+A]+offset) mod T=(UE_ID mod N). The offset can be zero. The offset, N is signaled by the gNB in SI or an RRC message. T is the length of the DRX cycle or LP WUS monitoring cycle. In one embodiment, if there are ‘N’ LP WUS radio frames in a DRX cycle, the UE may monitor the LP WUS occasion in a subframe/slot ‘A’ of SFN ‘B’ which satisfies (B*number of subframes/slots in a radio frame+A) mod T=(T div N)*(UE_ID mod N). N is signaled by the gNB in SI or an RRC message. T is the length of the DRX cycle or LP WUS monitoring cycle. In one embodiment, if there are ‘N’ LP WUS radio frames in a DRX cycle, the UE may monitor the LP WUS occasion in a subframe/slot ‘A’ of SFN ‘B’ which satisfies (B*number of subframes/slots in a radio frame+A) mod T=(UE_ID mod N). Nis signaled by the gNB in SI or an RRC message. T is the length of the DRX cycle or LP WUS monitoring cycle.

Note that the gNB may determine the LP WUS-Os monitored by the UE as above and transmit an LP WUS in the LP WUS-O when it needs to page the UE or when it needs to indicate to the UE to wakeup/monitor a PO.

At step 640, the UE receives the LP WUS in the monitored LP WUS-O. the LP WUS or LP WUS information/payload received in the monitored LP WUS-O indicates information to determine which paging occasion to monitor.

In one embodiment, the LP WUS or LP WUS information/payload received in the monitored LP WUS-O may include an index of a paging occasion to monitor. The valid PDCCH monitoring occasions for paging (determined based on a paging search space, the paging search space is signaled by the gNB e.g., in system information or an RRC message) occurring after the monitored LP WUS occasion (or occurring at an offset after the monitored LP WUS occasion or occurring at an offset after the end of radio frame/slot/subframe of the monitored LP WUS occasion) are sequentially grouped into paging occasions (POs) and numbered. The LP WUS or LP WUS information/payload received in the monitored LP WUS-O may include only one index of the paging occasion. This index is common for all UEs monitoring the LP WUS-O. In this case, if the LP WUS or LP WUS information/payload received in the monitored LP WUS-O indicates to monitor paging (or monitor a paging occasion), the UE monitors the paging occasion indicated by the index of the paging occasion received in the LP WUS or LP WUS information/payload. The UE may use the MR to monitor the indicated paging occasion. The UE may wakeup the MR to monitor the indicated paging occasion. The LP WUS or LP WUS information/payload received in the monitored LP WUS-O may include an index of paging occasion per subgroup (e.g., paging subgroup/LP WUS subgroup). The LP WUS-O may indicate whether to monitor the paging (or monitor paging occasion) on a per subgroup basis. A subgroup identity can be signaled to the UE by the network (e.g., a gNB or AMF or CN) or the subgroup identity can be determined by the UE based on its UE identity. For each subgroup for which paging monitoring (or monitoring paging occasion) is indicated, the LP WUS-O may indicate the index of the paging occasion to monitor. A maximum number of subgroups for which LP WUS-O may indicate whether to monitor paging or not can be signaled by the network (e.g., in an SI or RRC message). In this case, if the LP WUS or LP WUS information/payload received in the monitored LP WUS-O indicates to monitor paging (or monitor PO) for the UE's subgroup, the UE monitors the paging occasion indicated by the index of the paging occasion corresponding to its subgroup, received in the LP WUS or LP WUS information/payload. The UE may use the MR to monitor the indicated paging occasion. The UE may wakeup the MR to monitor the indicated paging occasion. The LP WUS or LP WUS information/payload received in the monitored LP WUS-O may include an index of a paging occasion for a specific purpose of paging e.g., for MBS paging or an SI update or emergency notifications or paging for specific a RAN or network slice(s). For each purpose for which paging monitoring (or monitoring paging occasion) is indicated, the LP WUS-O may indicate the index of paging occasion to monitor. In this case, if the LP WUS or LP WUS information/payload received in the monitored LP WUS-O indicates to monitor paging (or monitor a PO) for MBS paging and the UE is interested in MBS paging, the UE monitors the paging occasion indicated by the index of the paging occasion corresponding to MBS paging, received in the LP WUS or LP WUS information/payload. The UE may use the MR to monitor the indicated paging occasion. The UE may wakeup the MR to monitor the indicated paging occasion. If the LP WUS or LP WUS information/payload received in the monitored LP WUS-O indicates to monitor paging (or monitor PO) for an SI update/emergency notification and the UE is interested in the SI update/emergency notification, the UE monitors the paging occasion indicated by the index of the paging occasion corresponding to the SI update/emergency notification, received in the LP WUS or LP WUS information/payload. The UE may use the MR to monitor the indicated paging occasion. The UE may wakeup the MR to monitor the indicated paging occasion. If the LP WUS or LP WUS information/payload received in the monitored LP WUS-O indicates to monitor paging (or monitor a PO) for a specific RAN or network slice(s) and the UE belongs to or is interested in those RAN or network slice(s), the UE monitors the paging occasion indicated by the index of the paging occasion corresponding to the RAN or network slice(s), received in the LP WUS or LP WUS information/payload. The UE may use the MR to monitor the indicated paging occasion. They UE may wakeup the MR to monitor the indicated paging occasion.

In another embodiment, the LP WUS or LP WUS information/payload received in the monitored LP WUS-O may include a starting PDCCH monitoring occasion number of a paging occasion to monitor. The valid PDCCH monitoring occasions for paging (determined based on a paging search space, the paging search space is signaled by the gNB e.g., in system information or an RRC message) occurring after the monitored LP WUS occasion (or occurring at an offset after the monitored LP WUS occasion or occurring at an offset after the end of radio frame/slot/subframe of the monitored LP WUS occasion) are sequentially numbered. The LP WUS or LP WUS information/payload received in the monitored LP WUS-O may include only one starting PDCCH monitoring occasion number of the paging occasion. It is common for all UEs monitoring the LP WUS-O. In this case, if the LP WUS or LP WUS information/payload received in the monitored LP WUS-O indicates to monitor paging (or monitor the paging occasion), the UE monitors the paging occasion whose first PDCCH monitoring occasion is indicated by the starting PDCCH monitoring occasion number received in the LP WUS or LP WUS information/payload. The UE may use the MR to monitor the indicated paging occasion. The UE may wakeup the MR to monitor the indicated paging occasion. The LP WUS or LP WUS information/payload received in the monitored LP WUS-O may include a starting PDCCH monitoring occasion number of paging occasion per subgroup (e.g., paging subgroup/LP WUS subgroup). The LP WUS-O may indicate whether to monitor paging (or monitor a paging occasion) on a per paging subgroup basis. The subgroup identity can be signaled to the UE by the network (e.g., a gNB or AMF or CN) or it can be determined by the UE based on its UE identity. For each subgroup for which paging monitoring (or monitoring a paging occasion) is indicated, the LP WUS-O may indicate the starting PDCCH monitoring occasion number of the paging occasion to monitor. The maximum number of subgroups for which the LP WUS-O may indicate whether to monitor paging or not can be signaled by the network (e.g., in an SI or RRC message). In this case, if the LP WUS or LP WUS information/payload received in the monitored LP WUS-O indicates to monitor paging (or monitor a PO) for the UE's subgroup, the UE monitors the paging occasion whose first PDCCH monitoring occasion is indicated by the starting PDCCH monitoring occasion number corresponding to the UE's subgroup, received in the LP WUS or LP WUS information/payload. The UE may use the MR to monitor the indicated paging occasion. The UE may wakeup the MR to monitor the indicated paging occasion. The LP WUS or LP WUS information/payload received in the monitored LP WUS-O may include starting a PDCCH monitoring occasion number of a paging occasion for a specific purpose of paging e.g., for MBS paging or SI update or emergency notifications or paging for a specific RAN or network slice(s). For each purpose of paging for which the paging monitoring (or monitoring paging occasion) is indicated, the LP WUS-O may indicate the starting PDCCH monitoring occasion number of the paging occasion to monitor. In this case, if the LP WUS or LP WUS information/payload received in the monitored LP WUS-O indicates to monitor paging (or monitor a PO) for the MBS paging and the UE is interested in the MBS paging, the UE monitors the paging occasion whose first PDCCH monitoring occasion is indicated by the starting PDCCH monitoring occasion number corresponding to the MBS paging, received in the LP WUS or LP WUS information/payload. The UE may use the MR to monitor the indicated paging occasion. The UE may wakeup the MR to monitor the indicated paging occasion. If the LP WUS or LP WUS information/payload received in the monitored LP WUS-O indicates to monitor paging (or monitor a PO) for an SI update/emergency notification and the UE is interested in the SI update/emergency notification, the UE monitors the paging occasion whose first PDCCH monitoring occasion is indicated by the starting PDCCH monitoring occasion number corresponding to the SI update/emergency notification, received in the LP WUS or LP WUS information/payload. The UE may use the MR to monitor the indicated paging occasion. The UE may wakeup the MR to monitor the indicated paging occasion. If the LP WUS or LP WUS information/payload received in the monitored LP WUS-O indicates to monitor a paging (or monitor a PO) specific RAN or network slice(s) and the UE belongs to or is interested in one or more of the indicated RAN or network slice(s), the UE monitors the paging occasion whose first PDCCH monitoring occasion is indicated by the starting PDCCH monitoring occasion number corresponding to RAN or network slice(s), received in the LP WUS or LP WUS information/payload. The UE may use the MR to monitor the indicated paging occasion. The UE may wakeup the MR to monitor the indicated paging occasion.

In another embodiment, the LP WUS or LP WUS information/payload received in the monitored LP WUS-O may include a number (K) of POs for paging. Based on the current paging load and paging capacity of each paging message, the gNB may determine the number of POs in which it needs to page. The gNB pages in the POs with the index 0 to K-1. The valid PDCCH monitoring occasions for paging (determined based on a paging search space, the paging search space is signaled by the gNB e.g., in system information or an RRC message) occurring after the monitored LP WUS occasion (or occurring at an offset after the monitored LP WUS occasion or occurring at an offset after the end of radio frame/slot/subframe of the monitored LP WUS occasion) are sequentially grouped into paging occasions (POs) and numbered. In an alternate embodiment K can be signaled by the network in SI or RRC message. K can be common for all UEs monitoring the LP WUS-O. In this case, if the LP WUS or LP WUS information/payload received in the monitored LP WUS-O indicates to monitor paging (or monitor a paging occasion), the UE monitors the paging occasion with the index ‘i’ where i=UE_ID mod K. The UE may use the MR to monitor the paging occasion. The UE may wakeup the MR to monitor the paging occasion. K can be signaled per subgroup (e.g., paging subgroup/LP WUS subgroup). In this case, if the LP WUS or LP WUS information/payload received in the monitored LP WUS-O indicates to monitor paging (or monitor a paging occasion), the UE monitors the paging occasion with the index ‘i’ where i=UE_ID mod K, where K is number of POs for paging for UE's subgroup. The UE may use the MR to monitor the paging occasion. The UE may wakeup the MR to monitor the paging occasion.

In another embodiment, the LP WUS or LP WUS information/payload received in the monitored LP WUS-O may include a number (K) of POs for paging. In an alternate embodiment K can be signaled by the network in an SI or RRC message. The LP WUS or LP WUS information/payload indicates a starting PO number (j). Based on current paging load and paging capacity of each paging message, the gNB may determine the number of POs in which it needs to page. The gNB pages in the POs with the index j to j+K-1. The UE monitors the paging occasion with the index ‘i’ where i=j+UE_ID mod K. The UE may use the MR to monitor the paging occasion. The UE may wakeup the MR to monitor the paging occasion. K and J can be common for all UEs or can be per subgroup.

In another embodiment, the LP WUS or LP WUS information/payload received in the monitored LP WUS-O may indicate the specific radio frame/subframe/slot to determine the PO or PDCCH monitoring occasions for the PO. The PO to be monitored is the first ‘S*X’ valid PDCCH monitoring occasion for paging from the start of the indicated radio frame/subframe/slot. The radio frame can be indicated by the SFN. Alternately, the radio frames/subframes/slots after the LP WUS occasion can be sequentially indexed and this index of the radio frame/subframe/slot can be indicated.

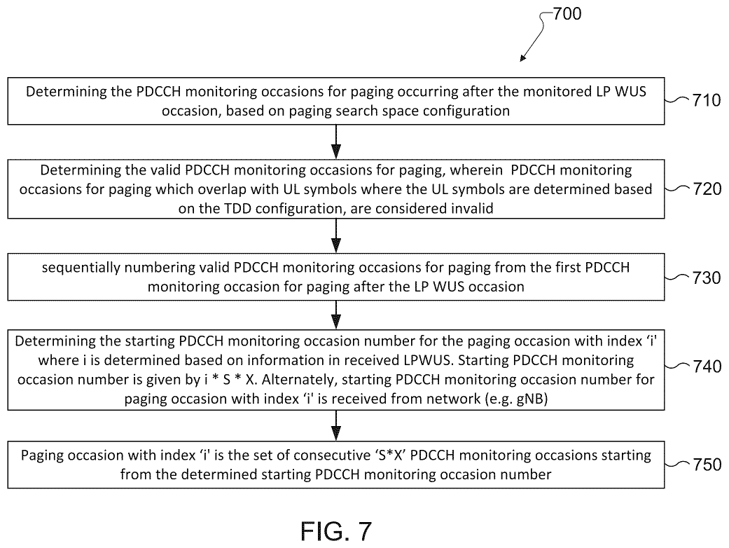

At step 650, the UE determines the paging occasion or the PDCCH monitoring occasions of the paging occasion based on the information received in the LP WUS or LP WUS payload. The paging occasion or the PDCCH monitoring occasions of the paging occasion are determined as illustrated in FIG. 7.

At step 660, the UE monitors the determined paging occasion. The UE monitors the PDCCH addressed to the P-RNTI in the PDCCH monitoring occasion of the determined paging occasion. If the PDCCH addressed to the P-RNTI is received in the monitored PDCCH monitoring occasion, the UE receives the TB on the PDSCH based on scheduling information (if included) in the DCI of the received PDCCH. The TB includes the paging message. If the PDCCH addressed to the P-RNTI is received in the monitored PDCCH monitoring occasion, short message/SI update notification/emergency notifications may be received in the DCI of received PDCCH.

Although FIG. 6 illustrates one example UE operation for paging reception 600, various changes may be made to FIG. 6. For example, while shown as a series of steps, various steps in FIG. 6 could overlap, occur in parallel, occur in a different order, occur any number of times, be omitted, or replaced by other steps.

FIG. 7 illustrates an example UE operation for determining a paging occasion or the PDCCH monitoring occasions of a paging occasion 700 according to embodiments of the present disclosure. An embodiment of the operation illustrated in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments for a UE operation for paging reception could be used without departing from the scope of this disclosure. In one embodiment, the UE may indicate/signal (e.g. in an RRC message) to the gNB its capability to support the operation illustrated in FIG. 7.

In the example of FIG. 7, the UE determines the paging occasion or the PDCCH monitoring occasions of the paging occasion based on the index (‘i’) of the paging occasion or starting PDCCH monitoring occasion number determined based on information received in a monitored LP WUS-O.

The operation of FIG. 7 beings at step 710. At step 710, the UE determines the PDCCH monitoring occasions for paging occurring after the monitored LP WUS occasion, based on the paging search space configuration.

At step 720 the UE determines the valid PDCCH monitoring occasions for paging. The PDCCH monitoring occasions for paging which overlap with UL symbols where the UL symbols are determined based on the TDD configuration, are considered invalid. In an alternate embodiment, the PDCCH monitoring occasions for paging which overlap with UL symbols and special symbols where the UL and special symbols are determined based on the TDD configuration, are considered invalid. The TDD configuration indicates the DL symbols, UL symbols and special symbols. The special symbols can be dynamically configured as DL or UL symbols. Note that this step is performed for a TDD cell. In the case of an FDD cell, this step may be omitted.

At step 730, the valid PDCCH monitoring occasions for paging occurring after the LP WUS occasion are grouped into paging occasions. In one embodiment, the valid PDCCH monitoring occasions for paging are sequentially numbered (e.g., from zero or one) starting from the first PDCCH monitoring occasion for paging after the LP WUS occasion. In another embodiment, the valid PDCCH monitoring occasions for paging are sequentially numbered (e.g., from zero or one) starting from the first PDCCH monitoring occasion for paging occurring after an ‘offset’ from the end of the LP WUS occasion. The ‘offset’ can be signaled by the network (e.g., a gNB) in system information or an RRC message or in the LP WUS or LP WUS information/payload. In another embodiment, the valid PDCCH monitoring occasions for paging are sequentially numbered (e.g., from zero or one) starting from the first PDCCH monitoring occasion for paging occurring after the radio frame or subframe or slot in which the UE monitored the LP WUS occasion. In another embodiment, the valid PDCCH monitoring occasions for paging are sequentially numbered (e.g., from zero or one) starting from the first PDCCH monitoring occasion for paging occurring after an ‘offset’ from the end of the radio frame or subframe or slot in which the UE monitored LP WUS occasion. The ‘offset’ can be signaled by the network (e.g., a gNB) in system information or an RRC message or in the LP WUS or LP WUS information/payload. In another embodiment, the valid PDCCH monitoring occasions for paging are sequentially numbered (e.g., from zero or one) starting from the first PDCCH monitoring occasion for paging in the radio frame/subframe/slot indicated by the network (e.g., a gNB) in the LP WUS or LP WUS payload or an SI or RRC message. The radio frame can be indicated by the SFN. Alternately, radio frames/subframes/slots after the LP WUS occasion can be sequentially indexed and this index of radio frame/subframe/slot can be indicated. In another embodiment, the valid PDCCH monitoring occasions for paging are sequentially numbered (e.g., from zero or one) starting from the first duration interval including the PDCCH monitoring occasions for paging, occurring after the LP WUS occasion (or occurring after an offset from the end of the LP WUS occasion or occurring after an offset from the end of frame/subframe/slot of the LP WUS occasion). Note that the search space configuration for paging includes a length of duration interval which occurs periodically (the period is indicated in the search space configuration) and includes one or more PDCCH monitoring occasions for paging.

At step 740, the UE determines the starting PDCCH monitoring occasion the index ‘i’. The paging occasion is a set of ‘S*X’ consecutive PDCCH monitoring occasions for paging (note that these consecutive PDCCH monitoring occasions for paging are the valid PDCCH monitoring occasions for paging) where ‘S’ is the number of actual transmitted SSBs or beams or reference signal, and X is the number of PDCCH monitoring occasions per SSB/beam/reference signal if configured or is equal to 1 otherwise. For example, if the starting PDCCH monitoring occasion number for a PO is 5 and ‘S*X’ equals 4, the PDCCH monitoring occasions for the PO are the PDCCH monitoring occasions with PDCCH monitoring occasion number 5, 6, 7 and 8. In one embodiment, the starting PDCCH monitoring occasion number for the paging occasion with index ‘i’ is given by i*S*X. ‘i’ equals 0, 1, 2, 3, 4, 5, etc. In another embodiment, the starting PDCCH monitoring occasion number for the paging occasion with index ‘i’ can be signaled by the network in the LP WUS payload or SI or an RRC message.

At step 750, the paging occasion with index ‘i’ is the set of consecutive ‘S*X’ PDCCH monitoring occasions starting from the determined starting PDCCH monitoring occasion number.

Although FIG. 7 illustrates one example UE operation for determining a paging occasion or the PDCCH monitoring occasions of a paging occasion 700, various changes may be made to FIG. 7. For example, while shown as a series of steps, various steps in FIG. 7 could overlap, occur in parallel, occur in a different order, occur any number of times, be omitted, or replaced by other steps.

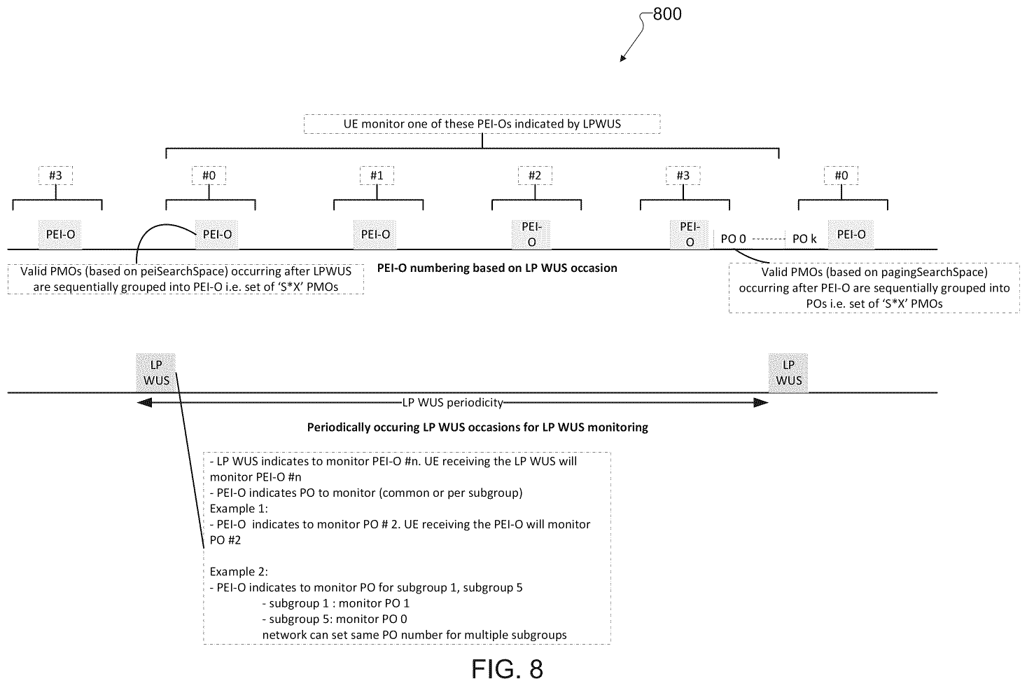

FIG. 8 illustrates another example 800 of paging transmission and reception according to embodiments of the present disclosure. The embodiment of paging transmission and reception of FIG. 8 is for illustration only. Different embodiments of paging transmission and reception could be used without departing from the scope of this disclosure. In one embodiment, the UE may indicate/signal (e.g. in an RRC message) to the gNB its capability to support the operation illustrated in FIG. 8.

In the Example of FIG. 8, the UE monitors for a time/frequency resource or occasion (e.g., an LP WUS occasion) periodically. The time/frequency resource or occasion or LP WUS occasion may be used interchangeably without departing from the scope of this disclosure. The resource or occasion may comprise of one of more symbols/slots/subframes etc. in the time domain and one or more resource elements or resource blocks in the frequency domain. The valid PDCCH monitoring occasions for paging early indication (determined based on paging early indication search space) occurring after the time/frequency resource or occasion or LP WUS occasion (or occurring at an offset after the time/frequency resource or occasion or LP WUS occasion or occurring at an offset after the end of radio frame/slot/subframe of the time/frequency resource or occasion or LP WUS occasion) are sequentially grouped into paging early indication occasions (PEI-Os) and numbered. As illustrated in FIG. 8, the valid PDCCH monitoring occasions for PEI occurring after the time/frequency resource or occasion or LP WUS occasion are sequentially grouped into PEI-O #0 to #3. Each PEI-O comprises a plurality of consecutive valid PDCCH monitoring occasions for PEI. In one embodiment, a plurality of consecutive valid PDCCH monitoring occasions in a PEI-O can be equal to S*X where S is the number of transmitted beams or SSBs or reference signals by the gNB in the cell and X is the number of PDCCH monitoring occasions per SSB/transmitted beam of the gNB/reference signal. S and X are signaled by the gNB in SI or an RRC message. X can be equal to 1 if not configured.

The valid PDCCH monitoring occasions for paging (determined based on paging search space) occurring after the PEI-O (or occurring at an offset after the PEI-O or occurring at an offset after the end of radio frame/slot/subframe of the PEI-O) are sequentially grouped into paging occasions (POs). As illustrated in FIG. 8, the valid PDCCH monitoring occasions for paging occurring after the PEI-O are sequentially grouped into PO #0 to #k. Each PO comprises a plurality of consecutive valid PDCCH monitoring occasions for paging. In one embodiment, the plurality of consecutive valid PDCCH monitoring occasions in PO can be equal to S*X where S is number of transmitted beams or SSBs or reference signals by the gNB in the cell and X is number of PDCCH monitoring occasions per SSB/transmitted beam of the gNB/reference signal. S and X are signaled by the gNB in a SI or RRC message. X can be equal to 1 if not configured.

In one embodiment, the LP WUS or LP WUS payload or payload or information received by the UE in the monitored time/frequency resource or occasion or LP WUS occasion indicates to monitor a specific PEI-O. The PEI-O indicates a specific PO to monitor. Alternately, the PEI-O indicates a specific PO per subgroup to monitor. As illustrated in FIG. 8, the LP WUS or LP WUS payload or payload or information received by the UE in the monitored time/frequency resource or occasion or LP WUS occasion indicates to monitor PEI-O #n. The UE monitors the PEI-O #n. The UE may use the MR to monitor the indicated PEI-O. The UE may wakeup the MR to monitor the indicated PEI-O. The gNB transmits PDCCH addressed to P-RNTI in PEI-O #n.

In one embodiment, the PEI-O indicates to monitor a specific PO which is common for all UEs monitoring the PEI-O. If the PEI indicates to monitor the PO for UE or UE's subgroup, the UE monitors the indicated PO. As illustrated in FIG. 8, a PEI received in the PEI-O indicates to monitor PO #2. The UE monitors the PO #2. The gNB transmits a PDCCH addressed to a P-RNTI in PO #2. For paging, DCI of this PDCCH includes scheduling information for a PDSCH TB, wherein the TB includes paging message.

In another embodiment, the PEI-O indicates to monitor a specific PO per paging subgroup. If the PEI indicates to monitor the PO for the UE's subgroup, the UE monitors the indicated PO corresponding to its subgroup. As illustrated in FIG. 8, the PEI received in the PEI-O indicates to monitor PO #1 for subgroup 1 and monitor PO #0 for subgroup 5. If the UE's subgroup is 1 and the PEI indicates to monitor the PO for subgroup 1, the UE monitors the paging occasion #1. If the UE's subgroup is 5 and the PEI indicates to monitor the PO for subgroup 5, The UE monitors the paging occasion #0. The UE may use the MR to monitor the indicated paging occasion. The UE may wakeup the MR to monitor the indicated paging occasion. The gNB transmits PDCCH addressed to a P-RNTI in PO #0. The paging DCI of this PDCCH includes scheduling information for a PDSCH TB, wherein the TB includes a paging message for paging UE(s) of subgroup 5. The gNB transmits PDCCH addressed to a P-RNTI in PO #1. The paging DCI of this PDCCH includes scheduling information for a PDSCH TB, wherein the TB includes a paging message for paging the UE(s) of subgroup 1.

Although FIG. 8 illustrates an example 800 of paging transmission and reception, various changes may be made to FIG. 8. For example, various changes to the LP WUS periodicity, the number of POs, etc. could be made according to particular needs.

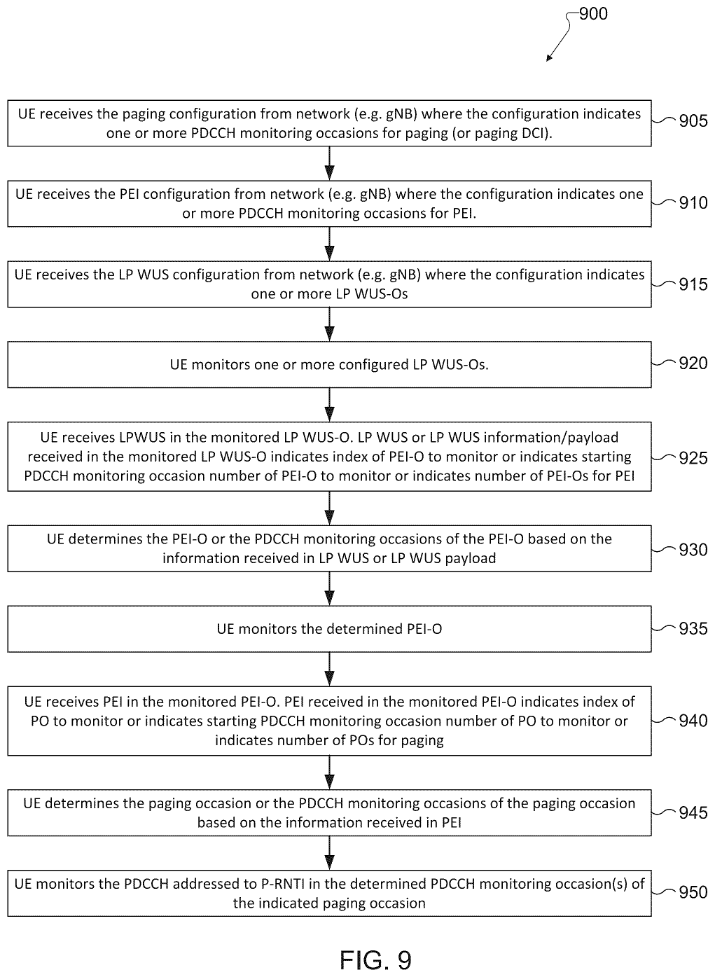

FIG. 9 illustrates another example UE operation for paging reception 900 according to embodiments of the present disclosure. An embodiment of the operation illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments for a UE operation for paging reception could be used without departing from the scope of this disclosure. In one embodiment, the UE may indicate/signal (e.g. in an RRC message) to the gNB its capability to support the operation illustrated in FIG. 9.

In the example of FIG. 9, the operation begins at step 905. At step 905, a UE, such as UE 116 of FIG. 1, receives the paging configuration from the network (e.g., a gNB) where the configuration indicates one or more PDCCH monitoring occasions for paging (or PDCCH monitoring occasions for paging DCI). The paging configuration is for the cell or TRP where the UE monitors paging. The cell can be the camped cell, in case the UE is in the RRC IDLE or RRC INACTIVE state. The cell can be the serving cell or PCell or SpCell, in case the UE is in the RRC_CONNECTED state. The paging configuration may be received from the cell where the UE monitors paging or from another cell. The cell can be the camped cell, in case the UE is in the RRC IDLE or RRC INACTIVE state. The cell can be the serving cell or PCell, in case the UE is in RRC_CONNECTED state. The paging configuration may be received in system information (e.g., in a system information block or SI message). The paging configuration may be received in an RRC message (e.g., in an RRC Reconfiguration message). The paging configuration may include a parameter ‘pagingSearchSpace’ to indicate one or more PDCCH monitoring occasions for paging (or PDCCH monitoring occasions for paging DCI). The parameter ‘pagingSearchSpace’ is set to the search space identifier of the search space amongst the one or more (common) search spaces configured in the cell and signaled by the network. A list of search space configurations can be signaled where each search space configuration is uniquely identified by a search space identifier. Each search space configuration indicates a location of PDCCH monitoring occasions in time and frequency. Using the parameter ‘pagingSearchSpace’ the UE identifies the search space configuration for PDCCH monitoring occasions of paging amongst the list of search space configurations. The parameter ‘pagingSearchSpace’ can be set to zero. ‘pagingSearchSpace’ set to zero indicates that the PDCCH monitoring occasions for paging are the same as PDCCH monitoring occasions for receiving RMSI or SIB1. The parameter to indicate PDCCH monitoring occasions for receiving RMSI or SIB1 is signaled by the network in a MIB.

At step 910, the UE receives the PEI configuration from the network (e.g., a gNB) where the configuration indicates one or more PDCCH monitoring occasions for PEI (or PDCCH monitoring occasions for PEI). The PEI configuration is for the cell or TRP where the UE monitors paging. The cell can be the camped cell, in case the UE is in the RRC IDLE or RRC INACTIVE state. The cell can be the serving cell or PCell or SpCell, in case the UE is in the RRC_CONNECTED state. The PEI configuration may be received from the cell where the UE monitors paging or from another cell. The cell can be the camped cell, in case UE is in the RRC IDLE or RRC INACTIVE state. The cell can be the serving cell or PCell, in case the UE is in the RRC_CONNECTED state. The PEI configuration may be received in system information (e.g., in a system information block or SI message). The PEI configuration may be received in an RRC message (e.g., in a RRC Reconfiguration message). The PEI configuration may include a parameter ‘pagingSearchSpace’ to indicate one or more PDCCH monitoring occasions for PEI (or PDCCH monitoring occasions for PEI). The parameter ‘peiSearchSpace’ is set to a search space identifier of a search space amongst the one or more (common) search spaces configured in the cell and signaled by the network. A list of search space configurations can be signaled where each search space configuration is uniquely identified by a search space identifier. Each search space configuration indicates a location of PDCCH monitoring occasions in time and frequency. Using the parameter ‘peiSearchSpace’ the UE identifies the search space configuration for PDCCH monitoring occasions of PEI amongst the list of search space configurations. The Parameter ‘peiSearchSpace’ can be set to zero. ‘peiSearchSpace’ set to zero indicates that PDCCH monitoring occasions for PEI are the same as PDCCH monitoring occasions for receiving RMSI or SIB1. A parameter to indicate PDCCH monitoring occasions for receiving RMSI or SIB1 is signaled by network in a MIB.

At step 915, the UE receives the LP WUS configuration from the network (e.g., a gNB) where the configuration indicates one or more LP WUS-Os. Each LP WUS-O may comprise one or more monitoring occasions. In one embodiment, the number of monitoring occasions in the LP WUS-O can be equal to S*X where S is the number of transmitted beams or SSBs by the gNB in the cell and X is the number of PDCCH monitoring occasions per SSB/transmitted beam. S and X are signaled by the gNB in SI or an RRC message. X can be equal to 1 if not configured. The LP WUS configuration is for the cell where the UE monitors paging. The cell can be the camped cell, in case UE is in the RRC IDLE or RRC INACTIVE state. The cell can be the serving cell or PCell or SpCell, in case the UE is in RRC_CONNECTED state. The LP WUS configuration may be received from the cell where the UE monitors paging. The cell can be the camped cell, in case UE is in the RRC IDLE or RRC INACTIVE state. The cell can be the serving cell or PCell or SpCell, in case the UE is in RRC_CONNECTED state. The LP WUS configuration may be received in system information (e.g., in a system information block or SI message). The LP WUS configuration may be received in an RRC message (e.g., in an RRC Reconfiguration message). The LP WUS configuration may signal a period and/offset and/or duration where the LP WUS-O(s) occurs periodically with the signaled period and first period may start at an offset from SFN 0. A starting time (e.g., slot/symbol), starting frequency resource (e.g., PRB index), number of PRBs and number of slots/symbols of each LP WUS monitoring occasion may also be included in the configuration.

At step 920, the UE monitors one or more configured LP WUS-Os. In one embodiment, the UE may monitor all the configured LP WUS-Os. In one embodiment, the UE may determine to monitor one or more LP WUS-Os from the configured LP WUS-Os based on the UE's identity (e.g., UE ID, S-TMSI, I-RNTI etc.). In one embodiment, the UE may determine to monitor one or more LP WUS-Os from the configured LP WUS-Os based on the UE's subgroup identity. The subgroup identity can be signaled to UE by the network (e.g., a gNB or AMF or CN) or the subgroup identity can be determined by the UE based on the UE's UE identity. In one embodiment, if there are ‘K’ LP WUS-Os in a DRX cycle, the UE may monitor the jth LP WUS-O where j=UE ID mod K. K is an integer>0. In one embodiment, if there are ‘N’ LP WUS radio frames in a DRX cycle, the UE may monitor the LP WUS-O in a radio frame whose SFN satisfies (SFN+offset) mod T=(T div N)*(UE_ID mod N); Offset can be zero. Offset, N is signaled by the gNB in SI or an RRC message. T is the length of the DRX cycle or LP WUS monitoring cycle. In one embodiment, if there are ‘N’ LP WUS radio frames in a DRX cycle, the UE may monitor the LP WUS-O in a radio frame whose SFN satisfies (SFN+offset) mod T=(UE_ID mod N). The offset can be zero. The Offset, N is signaled by the gNB in SI or an RRC message. T is the length of the DRX cycle or LP WUS monitoring cycle. In one embodiment, if there are ‘N’ LP WUS radio frames in a DRX cycle, the UE may monitor the LP WUS occasion in a radio frame whose SFN satisfies SFN mod T=(T div N)*(UE_ID mod N). Nis signaled by the gNB in SI or an RRC message. T is the length of the DRX cycle or LP WUS monitoring cycle. In one embodiment, if there are ‘N’ LP WUS radio frames in a DRX cycle, the UE may monitor the LP WUS occasion in a radio frame whose SFN satisfies SFN mod T=(UE_ID mod N). Nis signaled by the gNB in SI or an RRC message. T is the length of the DRX cycle or LP WUS monitoring cycle. In one embodiment, if there are ‘N’ LP WUS radio frames in a DRX cycle, the UE may monitor the LP WUS-O in a subframe/slot ‘A’ of SFN ‘B’ which satisfies ([B*number of subframes/slots in a radio frame+A]+offset) mod T=(T div N)*(UE_ID mod N). The offset can be zero. The offset, N is signaled by the gNB in SI or an RRC message. T is the length of the DRX cycle or LP WUS monitoring cycle. In one embodiment, if there are ‘N’ LP WUS radio frames in a DRX cycle, the UE may monitor the LP WUS-O in a subframe/slot ‘A’ of SFN ‘B’ which satisfies ((B*number of subframes/slots in a radio frame+A)+offset) mod T=(UE_ID mod N). The offset can be zero. The offset, N is signaled by the gNB in SI or an RRC message. T is the length of the DRX cycle or LP WUS monitoring cycle. In one embodiment, if there are ‘N’ LP WUS radio frames in a DRX cycle, the UE may monitor the LP WUS occasion in a subframe/slot ‘A’ of SFN ‘B’ which satisfies (B*number of subframes/slots in a radio frame+A) mod T=(T div N)*(UE_ID mod N). N is signaled by the gNB in SI or an RRC message. T is the length of the DRX cycle or LP WUS monitoring cycle. In one embodiment, if there are ‘N’ LP WUS radio frames in a DRX cycle, the UE may monitor the LP WUS occasion in a subframe/slot ‘A’ of SFN ‘B’ which satisfies (B*number of subframes/slots in a radio frame+A) mod T=(UE_ID mod N). N is signaled by the gNB in SI or an RRC message. T is the length of the DRX cycle or LP WUS monitoring cycle.

Note that gNB may determine the LP WUS-Os monitored by the UE as above and transmit an LP WUS in the LP WUS-O when it needs to page the UE or when it needs to indicate to the UE to wakeup/monitor a PEI-O/PO.

At step 925, the UE receives the LP WUS in the monitored LP WUS-O. The LP WUS or LP WUS information/payload received in the monitored LP WUS-O indicates information to determine which PEI-O to monitor.

In one embodiment, the LP WUS or LP WUS information/payload received in the monitored LP WUS-O may include an index of a PEI-O to monitor. The LP WUS or LP WUS information/payload received in the monitored LP WUS-O may include only one index of the PEI-O. This index is common for all UEs monitoring the LP WUS-O. In this case, if the LP WUS or LP WUS information/payload received in the monitored LP WUS-O indicates to monitor paging (or monitor a PEI-O), the UE monitors the PEI-O indicated by the index of the PEI-O received in the LP WUS or LP WUS information/payload. The UE may use the MR to monitor the indicated PEI-O. The UE may wakeup the MR to monitor the indicated PEI-O. The LP WUS or LP WUS information/payload received in the monitored LP WUS-O may include an index of a PEI-O per subgroup (e.g., paging subgroup/LP WUS subgroup). The LP WUS-O may indicate whether to monitor paging (or monitor a PEI-O) on a per subgroup basis. The subgroup identity can be signaled to the UE by the network (e.g., a gNB or AMF or CN) or the subgroup identity can be determined by the UE based on the UE's UE identity. For each subgroup for which paging monitoring (or monitoring a PEI-O) is indicated, the LP WUS-O may indicate the index of the PEI-O to monitor. A maximum number of subgroups for which the LP WUS-O may indicate whether to monitor paging or not can be signaled by the network (e.g., in SI or an RRC message). In this case, if the LP WUS or LP WUS information/payload received in the monitored LP WUS-O indicates to monitor paging (or monitor a PEI-O) for the UE's subgroup, the UE monitors the PEI-O indicated by the index of the PEI-O corresponding to its subgroup, received in the LP WUS or LP WUS information/payload. The UE may use the MR to monitor the indicated PEI-O. The UE may wakeup the MR to monitor the indicated PEI-O. The LP WUS or LP WUS information/payload received in the monitored LP WUS-O may include an index of a PEI-O for a specific purpose of paging e.g., for MBS paging or SI update or emergency notifications or paging for specific RAN or network slice(s). For each purpose for which paging monitoring (or monitoring PEI-O) is indicated, the LP WUS-O may indicate the index of a PEI-O to monitor. In this case, if the LP WUS or LP WUS information/payload received in the monitored LP WUS-O indicates to monitor paging (or monitor a PEI-O) for MBS paging and the UE is interested in the MBS paging, the UE monitors the PEI-O indicated by the index of PEI-O corresponding to the MBS paging, received in the LP WUS or LP WUS information/payload. The UE may use the MR to monitor the indicated PEI-O. The UE may wakeup the MR to monitor the indicated PEI-O. If the LP WUS or LP WUS information/payload received in the monitored LP WUS-O indicates to monitor paging (or monitor a PEI-O) for an SI update/emergency notification and the UE is interested in the SI update/emergency notification, the UE monitors the PEI-O indicated by the index of the PEI-O corresponding to the SI update/emergency notification, received in the LP WUS or LP WUS information/payload. The UE may use the MR to monitor the indicated PEI-O. The UE may wakeup the MR to monitor the indicated PEI-O. If the LP WUS or LP WUS information/payload received in the monitored LP WUS-O indicates to monitor paging (or monitor a PEI-O) for a specific RAN or network slice(s) and the UE belongs to or is interested in those RAN or network slice(s), the UE monitors the PEI-O indicated by the index of the PEI-O corresponding to the RAN or network slice(s), received in the LP WUS or LP WUS information/payload. The UE may use the MR to monitor the indicated PEI-O. The UE may wakeup the MR to monitor the indicated PEI-O.

In another embodiment, the LP WUS or LP WUS information/payload received in the monitored LP WUS-O may include a starting PDCCH monitoring occasion number of a PEI-O to monitor. The LP WUS or LP WUS information/payload received in the monitored LP WUS-O may include only one starting PDCCH monitoring occasion number of the PEI-O. It is common for all UEs monitoring the LP WUS-O. In this case, if the LP WUS or LP WUS information/payload received in the monitored LP WUS-O indicates to monitor paging (or monitor a PEI-O), the UE monitors the PEI-O whose first PDCCH monitoring occasion is indicated by the starting PDCCH monitoring occasion number received in the LP WUS or LP WUS information/payload. The UE may use the MR to monitor the indicated PEI-O. The UE may wakeup the MR to monitor the indicated PEI-O. The LP WUS or LP WUS information/payload received in the monitored LP WUS-O may include a starting PDCCH monitoring occasion number of the PEI-O per subgroup (e.g., a paging subgroup/LP WUS subgroup). The LP WUS-O may indicate whether to monitor paging (or monitor a PEI-O) on a per paging subgroup basis. The subgroup identity can be signaled to the UE by the network (e.g., a gNB or AMF or CN) or the subgroup identity can be determined by the UE based on the UE's UE identity. For each subgroup for which paging monitoring (or monitoring a PEI-O) is indicated, the LP WUS-O may indicate the starting PDCCH monitoring occasion number of the PEI-O to monitor. A maximum number of subgroups for which the LP WUS-O may indicate whether to monitor paging or not can be signaled by the network (e.g., in SI or an RRC message). In this case, if the LP WUS or LP WUS information/payload received in the monitored LP WUS-O indicates to monitor paging (or monitor a PEI-O) for the UE's subgroup, the UE monitors the PEI-O whose first PDCCH monitoring occasion is indicated by the starting PDCCH monitoring occasion number corresponding to its subgroup, received in the LP WUS or LP WUS information/payload. The UE may use the MR to monitor the indicated PEI-O. The UE may wakeup the MR to monitor the indicated PEI-O. The LP WUS or LP WUS information/payload received in the monitored LP WUS-O may include a starting PDCCH monitoring occasion number of PEI-O for a specific purpose of paging e.g., for MBS paging or SI update or emergency notifications or paging for a specific RAN or network slice(s). For each purpose of paging for which the paging monitoring (or monitoring PEI-O) is indicated, the LP WUS-O may indicate the starting PDCCH monitoring occasion number of a PEI-O to monitor. In this case, if the LP WUS or LP WUS information/payload received in the monitored LP WUS-O indicates to monitor paging (or monitor a PEI-O) for an MBS paging and the UE is interested in the MBS paging, the UE monitors the PEI-O whose first PDCCH monitoring occasion is indicated by the starting PDCCH monitoring occasion number corresponding to the MBS paging, received in the LP WUS or LP WUS information/payload. The UE may use the MR to monitor the indicated PEI-O. The UE may wakeup the MR to monitor the indicated PEI-O. If the LP WUS or LP WUS information/payload received in the monitored LP WUS-O indicates to monitor paging (or monitor PEI-O) for an SI update/emergency notification and the UE is interested in the SI update/emergency notification, the UE monitors the PEI-O whose first PDCCH monitoring occasion is indicated by the starting PDCCH monitoring occasion number corresponding to the SI update/emergency notification, received in the LP WUS or LP WUS information/payload. The UE may use the MR to monitor the indicated PEI-O. The UE may wakeup the MR to monitor the indicated PEI-O. If the LP WUS or LP WUS information/payload received in the monitored LP WUS-O indicates to monitor paging (or monitor a PEI-O) for a specific RAN or network slice(s) and UE belongs to or is interested in one or more of the indicated RAN or network slice(s), the UE monitors the PEI-O whose first PDCCH monitoring occasion is indicated by starting PDCCH monitoring occasion number corresponding to RAN or network slice(s), received in the LP WUS or LP WUS information/payload. The UE may use the MR to monitor the indicated PEI-O. The UE may wakeup the MR to monitor the indicated PEI-O.

In another embodiment, the LP WUS or LP WUS information/payload received in the monitored LP WUS-O may include a number (K) of PEI-Os for paging. Based on a current paging load and the capacity of each PEI, the gNB may determine the number of PEI-Os in which it needs to page. The gNB pages in the PEI-Os with index 0 to K-1. In an alternate embodiment K can be signaled by the network in SI or RRC message. K can be common for all UEs monitoring the LP WUS-O. In this case, if the LP WUS or LP WUS information/payload received in the monitored LP WUS-O indicates to monitor paging (or monitor a PEI-O), the UE monitors the PEI-O with index ‘i’ where i=UE_ID mod K. The UE may use the MR to monitor the PEI-O. The UE may wakeup the MR to monitor the PEI-O. K can be signaled per subgroup (e.g., paging subgroup/LP WUS subgroup). In this case, if the LP WUS or LP WUS information/payload received in the monitored LP WUS-O indicates to monitor paging (or monitor a PEI-O), the UE monitors the PEI-O with index ‘i’ where i=UE_ID mod K, where K is number of POs for paging for UE's subgroup. The UE may use the MR to monitor the PEI-O. The UE may wakeup the MR to monitor the PEI-O.

In another embodiment, the LP WUS or LP WUS information/payload received in the monitored LP WUS-O may include a number (K) of PEI-Os for paging. In an alternate embodiment K can be signaled by network in SI or RRC message. The LP WUS or LP WUS information/payload indicates a starting PEI-O number (j). Based on a current paging load and paging capacity, the gNB may determine the number of PEI-Os in which it needs to page. The gNB transmits a PEI in the PEI-Os with index j to j+K-1. The UE monitors the PEI-O with an index ‘i’ where i=j+UE_ID mod K. The UE may use the MR to monitor the PEI-O. The UE may wakeup the MR to monitor the PEI-O. K and J can be common for all UEs or can be per subgroup.

In another embodiment, the LP WUS or LP WUS information/payload received in the monitored LP WUS-O may indicate the specific radio frame/subframe/slot to determine the PEI-O or PDCCH monitoring occasions for PEI-O. PEI-O to be monitored is the first ‘S*X’ valid PDCCH monitoring occasions for the PEI from the start of the indicated radio frame/subframe/slot. The radio frame can be indicated by the SFN. Alternately, radio frames/subframes/slots after the LP WUS occasion can be sequentially indexed and this index of radio frame/subframe/slot can be indicated.

At step 930, the UE determines the PEI-O or the PDCCH monitoring occasions of the PEI-O based on the information received in the LP WUS or LP WUS payload.

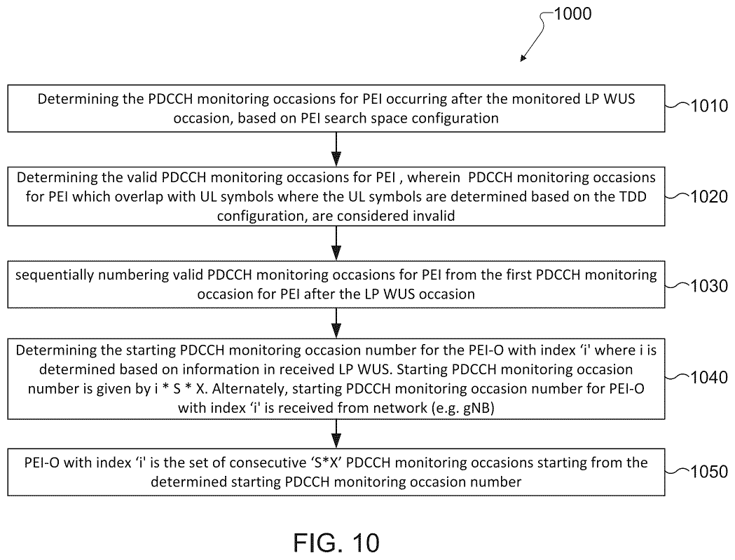

At step 935, the UE monitors the determined PEI-O. The UE monitors the PDCCH addressed to a P-RNTI in the PDCCH monitoring occasion of the determined PEI-O. The PEI-O or the PDCCH monitoring occasions of the PEI-O are determined as illustrated in FIG. 10.

At step 940, the UE receives PEI in the monitored PEI-O. The PEI indicates the UE or UE's subgroup to monitor a PO. The PEI received in the monitored PEI-O indicates information to determine which PO to monitor.

In one embodiment, the PEI received in the monitored PEI-O may include an index of a paging occasion to monitor. The PEI received in the monitored PEI-O may include only one index of the paging occasion. This index is common for all UEs monitoring the PEI-O. In this case, if the PEI received in the monitored PEI-O indicates to monitor paging (or monitor a paging occasion), the UE monitors the paging occasion indicated by the index of paging occasion received in the PEI. The UE may use the MR to monitor the indicated paging occasion. The UE may wakeup the MR to monitor the indicated paging occasion. The PEI received in the monitored PEI-O may include an index of a paging occasion per subgroup (e.g., a paging subgroup/LP WUS subgroup). The PEI-O may indicate whether to monitor paging (or monitor a paging occasion) on a per subgroup basis. A subgroup identity can be signaled to UE by the network (e.g., a gNB or AMF or CN) or the subgroup identity can be determined by the UE based on the UE's UE identity. For each subgroup for which paging monitoring (or monitoring a paging occasion) is indicated, the PEI-O may indicate the index of a paging occasion to monitor. A maximum number of subgroups for which the PEI-O may indicate whether to monitor paging or not can be signaled by the network (e.g., in SI or an RRC message). In this case, if the PEI in the monitored PEI-O indicates to monitor paging (or monitor a PO) for the UE's subgroup, the UE monitors the paging occasion indicated by the index of the paging occasion corresponding to its subgroup, received in the PEI. The UE may use the MR to monitor the indicated paging occasion. The UE may wakeup the MR to monitor the indicated paging occasion. The PEI received in the monitored PEI-O may include an index of a paging occasion for a specific purpose of paging e.g., for MBS paging or an SI update or emergency notifications or paging for a specific RAN or network slice(s). For each purpose for which paging monitoring (or monitoring a paging occasion) is indicated, the PEI-O may indicate the index of a paging occasion to monitor. In this case, if the PEI received in the monitored PEI-O indicates to monitor paging (or monitor a PO) for an MBS paging and the UE is interested in the MBS paging, the UE monitors the paging occasion indicated by the index of the paging occasion corresponding to the MBS paging, received in the PEI. The UE may use the MR to monitor the indicated paging occasion. The UE may wakeup the MR to monitor the indicated paging occasion. If the PEI received in the monitored PEI-O indicates to monitor paging (or monitor a PO) for an SI update/emergency notification and the UE is interested in the SI update/emergency notification, the UE monitors the paging occasion indicated by the index of the paging occasion corresponding to the SI update/emergency notification, received in the PEI. The UE may use the MR to monitor the indicated paging occasion. The UE may wakeup the MR to monitor the indicated paging occasion. If the PEI received in the monitored PEI-O indicates to monitor paging (or monitor a PO) for a specific RAN or network slice(s) and UE belongs to or is interested in the specific RAN or network slice(s), the UE monitors the paging occasion indicated by the index of the paging occasion corresponding to the RAN or network slice(s), received in the PEI. The UE may use the MR to monitor the indicated paging occasion. The UE may wakeup the MR to monitor the indicated paging occasion.

In another embodiment, the PEI received in the monitored PEI-O may include a starting PDCCH monitoring occasion number of a paging occasion to monitor. The PEI received in the monitored PEI-O may include only one starting PDCCH monitoring occasion number of a paging occasion. It is common for all UEs monitoring the PEI-O. In this case, if the PEI received in the monitored PEI-O indicates to monitor paging (or monitor a paging occasion), the UE monitors the paging occasion whose first PDCCH monitoring occasion is indicated by the starting PDCCH monitoring occasion number received in the PEI. The UE may use the MR to monitor the indicated paging occasion. The UE may wakeup the MR to monitor the indicated paging occasion. The PEI received in the monitored PEI-O may include a starting PDCCH monitoring occasion number of paging occasion per subgroup (e.g., a paging subgroup/LP WUS subgroup). The PEI-O may indicate whether to monitor paging (or monitor a paging occasion) on a per paging subgroup basis. A subgroup identity can be signaled to the UE by the network (e.g., a gNB or AMF or CN) or the subgroup identity can be determined by the UE based on the UE's UE identity. For each subgroup for which paging monitoring (or monitoring a paging occasion) is indicated, the PEI-O may indicate the starting PDCCH monitoring occasion number of the paging occasion to monitor. A maximum number of subgroups for which the PEI-O may indicate whether to monitor paging or not can be signaled by the network (e.g., in SI or an RRC message). In this case, if the PEI received in the monitored PEI-O indicates to monitor paging (or monitor a PO) for the UE's subgroup, the UE monitors the paging occasion whose first PDCCH monitoring occasion is indicated by the starting PDCCH monitoring occasion number corresponding to its subgroup, received in the PEI. The UE may use the MR to monitor the indicated paging occasion. The UE may wakeup the MR to monitor the indicated paging occasion. The PEI received in the monitored PEI-O may include a starting PDCCH monitoring occasion number of paging occasion for specific purpose of paging e.g., for an MBS paging or SI update or emergency notifications or paging for a specific RAN or network slice(s). For each purpose of paging for which paging monitoring (or monitoring a paging occasion) is indicated, the PEI-O may indicate the starting PDCCH monitoring occasion number of a paging occasion to monitor. In this case, if the PEI received in the monitored PEI-O indicates to monitor paging (or monitor a PO) for an MBS paging and the UE is interested in the MBS paging, the UE monitors the paging occasion whose first PDCCH monitoring occasion is indicated by the starting PDCCH monitoring occasion number corresponding to the MBS paging, received in the PEI. The UE may use the MR to monitor the indicated paging occasion. The UE may wakeup the MR to monitor the indicated paging occasion. If the PEI received in the monitored PEI-O indicates to monitor paging (or monitor a PO) for an SI update/emergency notification and the UE is interested in the SI update/emergency notification, the UE monitors the paging occasion whose first PDCCH monitoring occasion is indicated by the starting PDCCH monitoring occasion number corresponding to the SI update/emergency notification, received in the PEI. The UE may use the MR to monitor the indicated paging occasion. The UE may wakeup the MR to monitor the indicated paging occasion. If the PEI received in the monitored PEI-O indicates to monitor paging (or monitor a PO) for a specific RAN or network slice(s) and UE belongs to or is interested in one or more of the indicated RAN or network slice(s), the UE monitors the paging occasion whose first PDCCH monitoring occasion is indicated by starting the PDCCH monitoring occasion number corresponding to the RAN or network slice(s), received in the PEI. The UE may use the MR to monitor the indicated paging occasion. The UE may wakeup the MR to monitor the indicated paging occasion.

In another embodiment, the PEI received in the monitored PEI-O may include a number (K) of POs for paging. Based on current paging load and paging capacity of each paging message, the gNB may determine the number of POs in which it needs to page. The gNB pages in the POs with index 0 to K-1. In an alternate embodiment K can be signaled by the network in SI or an RRC message. K can be common for all UEs monitoring the PEI-O. In this case, if the PEI received in the monitored PEI-O indicates to monitor paging (or monitor a paging occasion), the UE monitors the paging occasion with an index ‘i’ where i=UE_ID mod K. The UE may use the MR to monitor the paging occasion. The UE may wakeup the MR to monitor the paging occasion. K can be signaled per subgroup (e.g., a paging subgroup/LP WUS subgroup). In this case, if the PEI received in the monitored PEI-O indicates to monitor paging (or monitor a paging occasion), the UE monitors the paging occasion with index ‘i’ where i=UE_ID mod K, where K is number of POs for paging for UE's subgroup. The UE may use the MR to monitor the paging occasion. The UE may wakeup the MR to monitor the paging occasion.

In another embodiment, the PEI received in the monitored PEI-O may include a number (K) of POs for paging. The PEI also indicates a starting PO number (j). Based on a current paging load and paging capacity of each paging message, the gNB may determines the number of POs in which it needs to page. In an alternate embodiment, K can be signaled by the network in SI or an RRC message. The gNB pages in the POs with index j to j+K-1. The UE monitors the paging occasion with index ‘i’ where i=j+UE_ID mod K. The UE may use the MR to monitor the paging occasion. The UE may wakeup the MR to monitor the paging occasion. K and J can be common for all UEs or can be per subgroup.

In another embodiment, the PEI received in the monitored PEI-O may indicate the specific radio frame/subframe/slot to determine the PO or PDCCH monitoring occasions for PO. The PO to be monitored is the first ‘S*X’ valid PDCCH monitoring occasion for paging from the start of the indicated radio frame/subframe/slot. The radio frame can be indicated by the SFN. Alternately, radio frames/subframes/slots after the LP WUS occasion can be sequentially indexed and this index of radio frame/subframe/slot can be indicated.

At step 945, the UE determines the paging occasion or the PDCCH monitoring occasions of the paging occasion based on the information received in PEI.

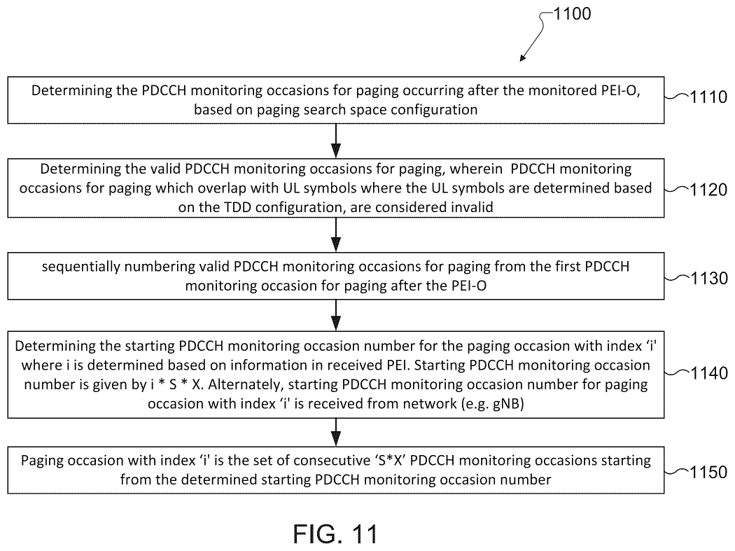

At step 950, the UE monitors the determined PO. The UE monitors the PDCCH addressed to the P-RNTI in the PDCCH monitoring occasion of the determined PO. The PO or the PDCCH monitoring occasions of the PO are determined as illustrated in FIG. 11. The UE receives the TB on PDSCH based on scheduling information (if included) in the DCI of the received PDCCH. The TB includes the paging message. If the PDCCH addressed to the P-RNTI is received in the monitored PDCCH monitoring occasion, short message/SI update notification/emergency notifications may be received in the DCI of received PDCCH.

Although FIG. 9 illustrates one example UE operation for paging reception 900, various changes may be made to FIG. 9. For example, while shown as a series of steps, various steps in FIG. 9 could overlap, occur in parallel, occur in a different order, occur any number of times, be omitted, or replaced by other steps.

FIG. 10 illustrates an example UE operation for determining a PEI-O or the PDCCH monitoring occasions of a PEI-O 1000 according to embodiments of the present disclosure. An embodiment of the operation illustrated in FIG. 10 is for illustration only. One or more of the components illustrated in FIG. 10 may be implemented in specialized circuitry configured to perform the noted functions or one or more of the components may be implemented by one or more processors executing instructions to perform the noted functions. Other embodiments for a UE operation for paging reception could be used without departing from the scope of this disclosure.

In the example of FIG. 10, the UE determines the PEI-O or the PDCCH monitoring occasions of the PEI-O based on the index (‘i’) of PEI-O or starting PDCCH monitoring occasion number determined based on information received in the monitored LP WUS-O. In one embodiment, the UE may indicate/signal (e.g. in an RRC message) to the gNB its capability to support the operation illustrated in FIG. 10.

The operation of FIG. 10 beings at step 1010. At step 1010, the UE determines the PDCCH monitoring occasions for the PEI occurring after the monitored LP WUS occasion, based on the PEI search space configuration.

At step 1020, the PDCCH monitoring occasions for PEI which overlap with UL symbols, where the UL symbols are determined based on the TDD configuration, are considered invalid. In an alternate embodiment, the PDCCH monitoring occasions for the PEI which overlap with UL symbols and special symbols, where the UL and special symbols are determined based on the TDD configuration, are considered invalid. The TDD configuration indicates the DL symbols, UL symbols and special symbols. Special symbols can be dynamically configured as DL or UL symbols. Note that this step is performed for a TDD cell. In the case of an FDD cell, this step may be skipped.

At step 1030, the valid PDCCH monitoring occasions for the PEI occurring after the LP WUS occasion are grouped into PEI occasions. In one embodiment, the valid PDCCH monitoring occasions for the PEI are sequentially numbered (e.g., from zero or one) starting from the first PDCCH monitoring occasion for the PEI after the LP WUS occasion. In another embodiment, the valid PDCCH monitoring occasions for the PEI are sequentially numbered (e.g., from zero or one) starting from the first PDCCH monitoring occasion for the PEI occurring after an ‘offset’ from the end of the LP WUS occasion. The ‘offset’ can be signaled by the network (e.g., a gNB) in system information or an RRC message or in the LP WUS or LP WUS information/payload. In another embodiment, the valid PDCCH monitoring occasions for the PEI are sequentially numbered (e.g., from zero or one) starting from the first PDCCH monitoring occasion for the PEI occurring after the radio frame or subframe or slot in which the UE monitored the LP WUS occasion. In another embodiment, the valid PDCCH monitoring occasions for the PEI are sequentially numbered (e.g., from zero or one) starting from the first PDCCH monitoring occasion for the PEI occurring after an ‘offset’ from the end of the radio frame or subframe or slot in which the UE monitored the LP WUS occasion. The ‘offset’ can be signaled by the network (e.g., a gNB) in system information or an RRC message or in the LP WUS or LP WUS information/payload. In another embodiment, the valid PDCCH monitoring occasions for the PEI are sequentially numbered (e.g., from zero or one) starting from the first PDCCH monitoring occasion for the PEI in the radio frame/subframe/slot indicated by the network (e.g., a gNB) in the LP WUS or LP WUS payload or SI or an RRC message. The radio frame can be indicated by the SFN. Alternately, radio frames/subframes/slots after the LP WUS occasion can be sequentially indexed and this index of the radio frame/subframe/slot can be indicated. In another embodiment, the valid PDCCH monitoring occasions for PEI are sequentially numbered (e.g., from zero or one) starting from the first duration interval including the PDCCH monitoring occasions for the PEI, occurring after the LP WUS occasion (or occurring after an offset from the end of the LP WUS occasion or occurring after an offset from the end of frame/subframe/slot of the LP WUS occasion). Note that the search space configuration for the PEI includes a length of duration interval which occurs periodically (the period is indicated in the search space configuration) and includes one or more PDCCH monitoring occasions for the PEI.

At step 1040, the UE determines the starting PDCCH monitoring occasion number for the PEI-O with index ‘i’. The PEI occasion is a set of ‘S*X’ consecutive PDCCH monitoring occasions for PEI (note that these consecutive PDCCH monitoring occasions for PEI are the valid PDCCH monitoring occasions for PEI) where ‘S’ is the number of actual transmitted SSBs or beams, and X is the number of PDCCH monitoring occasions per SSB/beam if configured or is equal to 1 otherwise. For example, if the starting PDCCH monitoring occasion number for a PEI-O is 5 and ‘S*X’ equals 4, the PDCCH monitoring occasions for the PEI-O are the PDCCH monitoring occasions with PDCCH monitoring occasion number 5, 6, 7 and 8. In one embodiment, the starting PDCCH monitoring occasion number for the PEI-O with index ‘i’ is given by i*S*X. ‘i’ equals 0, 1, 2, 3, 4, 5, etc. In another embodiment the starting PDCCH monitoring occasion number for the PEI-O with index ‘i’ can be signaled by network in the LP WUS payload or SI or an RRC message.

At step 1050, the PEI-O with index ‘i’ is the set of consecutive ‘S*X’ PDCCH monitoring occasions starting from the determined starting PDCCH monitoring occasion number.

Although FIG. 10 illustrates one example UE operation for determining a PEI-O or the PDCCH monitoring occasions of a PEI-O 1000, various changes may be made to FIG. 10. For example, while shown as a series of steps, various steps in FIG. 10 could overlap, occur in parallel, occur in a different order, occur any number of times, be omitted, or replaced by other steps.

FIG. 11 illustrates another example UE operation for determining a paging occasion or the PDCCH monitoring occasions of a paging occasion 1100 according to embodiments of the present disclosure. An embodiment of the operation illustrated in FIG. 11 is for illustration only. One or more of the components illustrated in FIG. 11 may be implemented in specialized circuitry configured to perform the noted functions or one or more of the components may be implemented by one or more processors executing instructions to perform the noted functions. Other embodiments for a UE operation for paging reception could be used without departing from the scope of this disclosure. In an embodiment, UE may indicate/signal (e.g. in RRC message) to gNB its capability to support the operation illustrated in FIG. 11.

In the example of FIG. 11 the UE determines the paging occasion or the PDCCH monitoring occasions of the paging occasion based on the index (‘i’) of the paging occasion or starting PDCCH monitoring occasion number determined based on information received in the monitored PEI-O in accordance with an embodiment of this disclosure.

The operation of FIG. 11 beings at step 1110. At step 1110, the UE determines the PDCCH monitoring occasions for paging occurring after the monitored PEI-O, based on the paging search space configuration.

At step 1120, the PDCCH monitoring occasions for paging which overlap with UL symbols, where the UL symbols are determined based on the TDD configuration, are considered invalid. In another embodiment, the PDCCH monitoring occasions for paging which overlap with UL symbols and special symbols, where the UL and special symbols are determined based on the TDD configuration, are considered invalid. The TDD configuration indicates the DL symbols, UL symbols and special symbols. The special symbols can be dynamically configured as DL or UL symbols. Note that this step is performed for a TDD cell. In the case of an FDD cell, this step may be skipped.

At step 1130, the valid PDCCH monitoring occasions for paging occurring after the PEI-O are grouped into paging occasions. In one embodiment, the valid PDCCH monitoring occasions for paging are sequentially numbered (e.g., from zero or one) starting from the first PDCCH monitoring occasion for paging after the PEI-O. In another embodiment, the valid PDCCH monitoring occasions for paging are sequentially numbered (e.g., from zero or one) starting from the first PDCCH monitoring occasion for paging occurring after an ‘offset’ from the end of the PEI-O. The ‘offset’ can be signaled by the network (e.g., a gNB) in system information or an RRC message or in the PEI. In another embodiment, the valid PDCCH monitoring occasions for paging are sequentially numbered (e.g., from zero or one) starting from the first PDCCH monitoring occasion for paging occurring after the radio frame or subframe or slot in which the UE monitored the PEI-O. In another embodiment, the valid PDCCH monitoring occasions for paging are sequentially numbered (e.g., from zero or one) starting from the first PDCCH monitoring occasion for paging occurring after an ‘offset’ from the end of the radio frame or subframe or slot in which the UE monitored the PEI-O. The ‘offset’ can be signaled by the network (e.g., a gNB) in system information or an RRC message or in the PEI. In another embodiment, the valid PDCCH monitoring occasions for paging are sequentially numbered (e.g., from zero or one) starting from the first PDCCH monitoring occasion for paging in the radio frame/subframe/slot indicated by the network (e.g., a gNB) in the PEI or SI or an RRC message. The radio frame can be indicated by the SFN. Alternately, radio frames/subframes/slots after the PEI-O can be sequentially indexed and this index of radio frame/subframe/slot can be indicated. In another embodiment, the valid PDCCH monitoring occasions for paging are sequentially numbered (e.g., from zero or one) starting from the first duration interval including the PDCCH monitoring occasions for paging, occurring after the PEI-O (or occurring after an offset from the end of the PEI-O or occurring after an offset from the end of the frame/subframe/slot of PEI-O). Note that search space configuration for paging includes a length of a duration interval which occurs periodically (the period is indicated in the search space configuration) and includes one or more PDCCH monitoring occasions for paging.

At step 1140, the UE determining the starting PDCCH monitoring occasion number for the paging occasion with index ‘i’. The paging occasion is a set of ‘S*X’ consecutive PDCCH monitoring occasions for paging (note that these consecutive PDCCH monitoring occasions for paging are the valid PDCCH monitoring occasions for paging) where ‘S’ is the number of actual transmitted SSBs or beams, and X is the number of PDCCH monitoring occasions per SSB/beam if configured or is equal to 1 otherwise. For example, if the starting PDCCH monitoring occasion number for a PO is 5 and ‘S*X’ equals 4, the PDCCH monitoring occasions for the PO are the PDCCH monitoring occasions with PDCCH monitoring occasion number 5, 6, 7 and 8. In one embodiment, the starting PDCCH monitoring occasion number for the paging occasion with index ‘i’ is given by i*S*X. ‘i’ equals 0, 1, 2, 3, 4, 5, etc. In another embodiment the starting PDCCH monitoring occasion number for the paging occasion with index ‘i’ can be signaled by the network in the PEI-O or SI or an RRC message.

At step 1150, the paging occasion with index ‘i’ is the set of consecutive ‘S*X’ PDCCH monitoring occasions starting from the determined starting PDCCH monitoring occasion number.

Although FIG. 11 illustrates one example UE operation for determining a paging occasion or the PDCCH monitoring occasions of a paging occasion 1100, various changes may be made to FIG. 11. For example, while shown as a series of steps, various steps in FIG. 11 could overlap, occur in parallel, occur in a different order, occur any number of times, be omitted, or replaced by other steps.

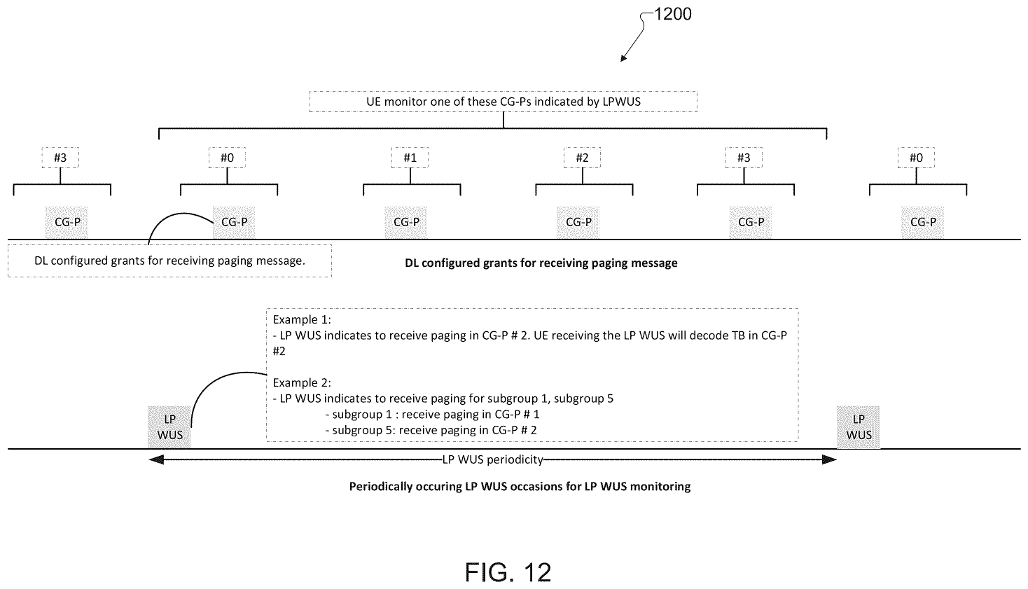

FIG. 12 illustrates another example 1200 of paging transmission and reception according to embodiments of the present disclosure. The embodiment of paging transmission and reception of FIG. 12 is for illustration only. Different embodiments of paging transmission and reception could be used without departing from the scope of this disclosure. In an embodiment, UE may indicate/signal (e.g. in RRC message) to gNB its capability to support the operation illustrated in FIG. 12.

In the example of FIG. 12, the UE monitors for a time/frequency resource or occasion (e.g., LP WUS occasion or paging occasion or PEI-O etc.) periodically. In one embodiment, the network (e.g., a gNB) signals a configured grant configuration for paging. The configuration indicates one or more configured grant occasions (or configured grants or grants or resources) for paging (a configured grant occasion for paging can be referred to as a CG-P). The configured grant occasion (or configured grant or grant or resource) may occur at a periodic interval. The Configuration may be signaled in SI or an RRC message. In one embodiment, the configured grant occasions (or configured grants or grants or resources) for paging occurring after the time/frequency resource or occasion or LP WUS occasion or paging occasion or PEI-O (or occurring at an offset after the time/frequency resource or occasion or LP WUS occasion or paging occasion or PEI-O occurring at an offset after the end of the radio frame/slot/subframe of the time/frequency resource or occasion or LP WUS occasion or paging occasion or PEI-O) are sequentially numbered. As illustrated in FIG. 12, the configured grant occasions (or configured grants or grants or resources) for paging occurring after the time/frequency resource or occasion or LP WUS occasion or paging occasion or PEI-O are sequentially numbered from CG-P #0 to #3. In one embodiment, the LP WUS or LP WUS payload or payload or information received by the UE in the monitored time/frequency resource or occasion or LP WUS occasion or paging occasion or PEI-O indicates to monitor a specific configured grant occasion (or configured grant or grant or resource) for paging (CG-P). In one embodiment, the configured grant occasions (or configured grants or grants or resources) for paging occurring after the time/frequency resource or occasion or LP WUS occasion or paging occasion or PEI-O (or occurring at an offset after the time/frequency resource or occasion or LP WUS occasion or paging occasion or PEI-O occurring at an offset after the end of the radio frame/slot/subframe of the time/frequency resource or occasion or LP WUS occasion or paging occasion or PEI-O) are grouped into sets of ‘S*X’ configured grant occasions and these sets are sequentially numbered, where S is the number of transmitted beams or SSBs or reference signals by the gNB in the cell and X is the number of occasions per SSB/transmitted beam/reference signal. In one embodiment, the LP WUS or LP WUS payload or payload or information received by the UE in the monitored time/frequency resource or occasion or LP WUS occasion or paging occasion or PEI-O indicates to monitor a specific set of configured grant occasions (or configured grants or grant or resources) for paging (CG-P) by indicating the set index or by indicating the starting CG-P number.

In the case of beamforming, the monitored time/frequency resource or occasion or LP WUS-O comprises ‘S*X’ LP WUS monitoring occasions (or time/frequency resources or occasions), where S is number of transmitted beams or SSBs or reference signals by the gNB in the cell and X is the number of occasions per SSB/transmitted beam/reference signal. Each LP WUS monitoring occasion (or time/frequency resource or occasion) is mapped to an SSB/TX beam/reference signal. The LP WUS received in an LP WUS monitoring occasion (or time/frequency resource or occasion) mapped to an SSB/TX beam/reference signal, indicates a CG occasion index of the CG in which the paging message is transmitted in the same coverage as that of the SSB/TX beam/reference signal.

The UE may use the MR to monitor the indicated CG-P or set of CG-Ps. The UE may wakeup the MR to monitor the indicated CG-P or set of CG-Ps. The gNB transmits a PDSCH TB (or TB) in the indicated CG-P or set of CG-Ps wherein the TB includes a paging message. The UE receives and decodes the PDSCH TB in the indicated CG-P or set of CG-Ps and receives the paging message. In one embodiment, the LP WUS or LP WUS payload or payload or information received by the UE in the monitored time/frequency resource or occasion or LP WUS occasion or paging occasion or PEI-O indicates to monitor a specific configured grant occasion for paging (CG-P) or set of CG-Ps which is common for all UEs monitoring the time/frequency resource or occasion or LP WUS occasion or paging occasion or PEI-O. As illustrated in FIG. 12, the LP WUS or LP WUS payload or payload or information received by the UE in the monitored time/frequency resource or occasion or LP WUS occasion or paging occasion or PEI-O indicates to monitor the configured grant occasion #n for paging (CG-P #n). The UE monitors the CG-P #n. The UE receives and decodes PDSCH TB (or TB) in the indicated CG-P #n and receives the paging message. In another embodiment, the LP WUS or LP WUS payload or payload or information received by the UE in the monitored time/frequency resource or occasion or LP WUS occasion or paging occasion or PEI-O indicates to monitor a specific configured grant occasion for paging (CG-P) per subgroup. If the LP WUS or LP WUS payload or payload or information received by the UE in the monitored time/frequency resource or occasion or LP WUS occasion or paging occasion or PEI-O indicates paging for the UE's subgroup, the UE monitors the indicated CG-P corresponding to its subgroup. As illustrated in FIG. 12, the LP WUS or LP WUS payload or payload or information received by the UE in the monitored time/frequency resource or occasion or LP WUS occasion or paging occasion or PEI-O indicates to monitor CG-P #1 for subgroup 1 and monitor CG-P #0 for subgroup 5. If the UE's subgroup is 1, the UE monitors the CG-P #1, the UE receives and decodes PDSCH TB (or TB) in indicated CG-P #1 and receives the paging message. If the UE's subgroup is 5, the UE monitors the CG-P #0, the UE receives and decodes the PDSCH TB (or TB) in indicated CG-P #0 and receives the paging message. The gNB transmits the PDSCH TB (or TB) including the paging message in CG-P #O where the paging message is for the UE(s) of subgroup 5. The gNB transmits the PDSCH TB (or TB) including the paging message in CG-P #1, where the paging message is for UE(s) of subgroup 1.

In one embodiment, multiple configured grant configurations for paging can be signaled, where each configured grant configuration for paging is associated to one or more SSBs/TX beams and the associated SSBs/TX beams are signaled in the configuration. The CG occasions of configured grant configuration for paging are sequentially mapped to associated SSBs/TX beams wherein each CG occasion can be mapped to one or more SSBs/TX beams, number of SSBs/TX beams mapped to one CG occasion can be signaled in configuration.

In one embodiment, instead of indicating a configured grant occasion for paging, the PDSCH scheduling info for receiving and decoding the TB can be included in the LP WUS or LP WUS payload or payload or information received by the UE in the monitored time/frequency resource or occasion or LP WUS occasion or paging occasion or PEI-O. Based on this information, the UE receives and decodes the TB and receives paging message.

In one embodiment, one or more OFDM symbols in a slot/subframe/radio frame, one or more PRBs and MCS for receiving paging message can be indicated in system information or an RRC message. A specific radio frame/subframe/slot to receive the paging message can be included in the LP WUS or LP WUS payload or payload or information received by the UE in the monitored time/frequency resource or occasion or LP WUS occasion or paging occasion or PEI-O or the specific radio frame/subframe/slot to receive paging message can be pre-defined (or can be at a configurable offset) with respect to the monitored time/frequency resource or occasion or LP WUS occasion or paging occasion or PEI-O. The UE receives the TB including the paging message in the radio frame/subframe/slot indicated by the LP WUS or LP WUS payload or payload or information received by the UE in the monitored time/frequency resource or occasion or LP WUS occasion or paging occasion or PEI-O, wherein TB including the paging message is received in OFDM symbols/PRBs indicated in system information or an RRC message.

In one embodiment, the LP WUS/LP WUS-O can be a PEI/PEI-O. In another embodiment, the LP WUS/LP WUS-O can be a PDCCH addressed to a P-RNTI/PO.

Although FIG. 12 illustrates an example 1200 of paging transmission and reception, various changes may be made to FIG. 12. For example, various changes to the LP WUS periodicity, the number of DL configured grants, etc. could be made according to particular needs.

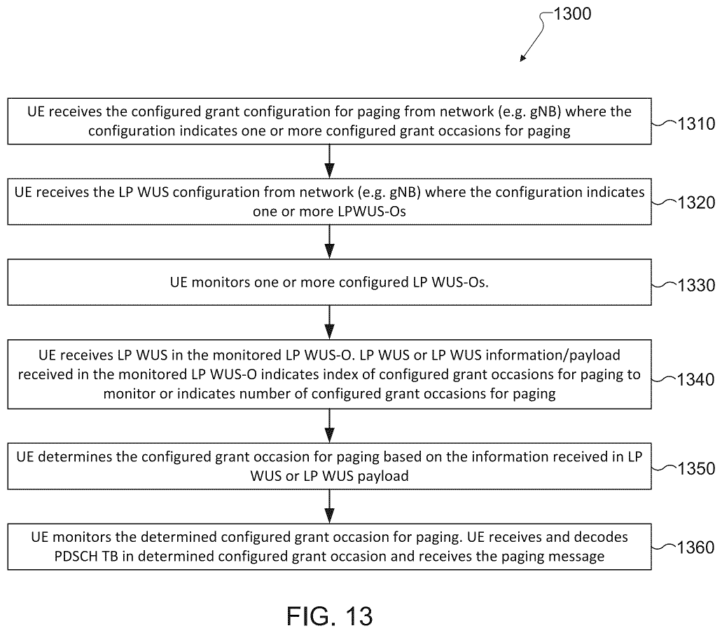

FIG. 13 illustrates another example UE operation for paging reception 1300 according to embodiments of the present disclosure. An embodiment of the operation illustrated in FIG. 13 is for illustration only. One or more of the components illustrated in FIG. 13 may be implemented in specialized circuitry configured to perform the noted functions or one or more of the components may be implemented by one or more processors executing instructions to perform the noted functions. Other embodiments for a UE operation for paging reception could be used without departing from the scope of this disclosure. In an embodiment, UE may indicate/signal (e.g. in RRC message) to gNB its capability to support the operation illustrated in FIG. 13.

In the example of FIG. 13, the operation begins at step 1310. At step 1310, a UE, such as UE 116 of FIG. 1, receives the configured grant configuration for paging from the network (e.g., a gNB). The configuration indicates one or more configured grant occasions for paging (CG-P). The configured grant occasions may occur at a periodic interval. The configured grant configuration for paging is for the cell where the UE monitors paging. The cell can be the camped cell, in case the UE is in the RRC IDLE or RRC INACTIVE state. The cell can be the serving cell or PCell or SpCell, in case the UE is in the RRC_CONNECTED state. The configured grant configuration for paging may be received from the cell where the UE monitors paging or from another cell. The cell can be the camped cell, in case the UE is in the RRC IDLE or RRC INACTIVE state. The cell can be the serving cell or PCell, in case the UE is in the RRC_CONNECTED state. The configured grant configuration for paging may be received in system information (e.g., in a system information block or an SI message). The configured grant configuration for paging may be received in an RRC message (e.g., in an RRC Reconfiguration message). In one embodiment, multiple configured grant configurations for paging can be signaled, where each configured grant configuration for paging is associated to one or more SSBs/TX beams and the associated SSBs/TX beams are signaled in the configuration. The CG occasions of configured grant configuration for paging are sequentially mapped to associated SSBs/TX beams, wherein each CG occasion can be mapped to one or more SSBs/TX beams. The number of SSBs/TX beams mapped to one CG occasion can be signaled in the configuration.

At step 1320, the UE receives the LP WUS configuration from the network (e.g., a gNB) where the configuration indicates one or more LP WUS-Os. Each LP WUS-O may comprise one or more monitoring occasions. In one embodiment, the number monitoring occasions in the LP WUS-O can be equal to S*X, where S is number of transmitted beams or SSBs by the gNB in the cell and X is number of PDCCH monitoring occasions per SSB/transmitted beam. S and X are signaled by the gNB in SI or an RRC message. X can be equal to 1 if not configured. The LP WUS configuration is for the cell where the UE monitors paging. The cell can be the camped cell, in case the UE is in the RRC IDLE or RRC INACTIVE state. The cell can be the serving cell or PCell or SpCell, in case the UE is in the RRC_CONNECTED state. The LP WUS configuration may be received from the cell where the UE monitors paging. The cell can be the camped cell, in case the UE is in the RRC IDLE or RRC INACTIVE state. The cell can be the serving cell or PCell or SpCell, in case the UE is in the RRC_CONNECTED state. The LP WUS configuration may be received in system information (e.g., in a system information block or SI message). The LP WUS configuration may be received in an RRC message (e.g., in an RRC Reconfiguration message). The LP WUS configuration may signal a period and/offset and/or duration where the LP WUS-O(s) occurs periodically with the signaled period. The first period may start at an offset from the SFN 0, starting time (e.g., slot/symbol), starting frequency resource (e.g., PRB index), number of PRBs, and the number of slots/symbols of each LP WUS monitoring occasion may also be included in the configuration.

At step 1330, the UE monitors one or more configured LP WUS-Os. In one embodiment, the UE may monitor all the configured LP WUS-Os. In one embodiment, the UE may determine to monitor one or more LP WUS-Os from the configured LP WUS-Os based on the UE's identity (e.g., UE ID, S-TMSI, I-RNTI etc.). In one embodiment, the UE may determine to monitor one or more LP WUS-Os from the configured LP WUS-Os based on the UE's subgroup identity. The subgroup identity can be signaled to the UE by the network (e.g., a gNB or AMF or CN) or the subgroup identity can be determined by UE based on the UE's UE identity. In one embodiment, if there are ‘K’ LP WUS-Os in a DRX cycle, the UE may monitor the jth LP WUS-O, where j=UE ID mod K. K is an integer>0. In one embodiment, if there are ‘N’ LP WUS radio frames in a DRX cycle, the UE may monitor the LP WUS-O in a radio frame whose SFN satisfies SFN+offset) mod T=(T div N)*(UE_ID mod N). The offset can be zero. The offset, Nis signaled by the gNB in SI or an RRC message. T is the length of the DRX cycle or LP WUS monitoring cycle. In one embodiment, if there are ‘N’ LP WUS radio frames in a DRX cycle, the UE may monitor the LP WUS-O in a radio frame whose SFN satisfies (SFN+offset) mod T=(UE_ID mod N). The offset can be zero. The offset, N is signaled by the gNB in SI or an RRC message. T is the length of the DRX cycle or LP WUS monitoring cycle. In one embodiment, if there are ‘N’ LP WUS radio frames in a DRX cycle, the UE may monitor the LP WUS occasion in a radio frame whose SFN satisfies SFN mod T=(T div N)*(UE_ID mod N). Nis signaled by the gNB in SI or an RRC message. T is the length of the DRX cycle or LP WUS monitoring cycle. In one embodiment, if there are ‘N’ LP WUS radio frames in a DRX cycle, the UE may monitor the LP WUS occasion in a radio frame whose SFN satisfies SFN mod T=(UE_ID mod N). N is signaled by the gNB in SI or an RRC message. T is the length of the DRX cycle or LP WUS monitoring cycle. In one embodiment, if there are ‘N’ LP WUS radio frames in a DRX cycle, the UE may monitor the LP WUS-O in a subframe/slot ‘A’ of SFN ‘B’ which satisfies ([B*number of subframes/slots in a radio frame+A]+offset) mod T=(T div N)*(UE_ID mod N). The offset can be zero. The offset, N is signaled by the gNB in SI or an RRC message. T is the length of the DRX cycle or LP WUS monitoring cycle. In one embodiment, if there are ‘N’ LP WUS radio frames in a DRX cycle, the UE may monitor the LP WUS-O in a subframe/slot ‘A’ of SFN ‘B’ which satisfies ([B*number of subframes/slots in a radio frame+A]+offset) mod T=(UE_ID mod N). The offset can be zero. The offset, N is signaled by the gNB in SI or an RRC message. T is the length of the DRX cycle or LP WUS monitoring cycle. In one embodiment, if there are ‘N’ LP WUS radio frames in a DRX cycle, the UE may monitor the LP WUS occasion in a subframe/slot ‘A’ of SFN ‘B’ which satisfies (B*number of subframes/slots in a radio frame+A) mod T=(T div N)*(UE_ID mod N). N is signaled by the gNB in SI or an RRC message. T is the length of the DRX cycle or LP WUS monitoring cycle. In one embodiment, if there are ‘N’ LP WUS radio frames in a DRX cycle, the UE may monitor the LP WUS occasion in a subframe/slot ‘A’ of SFN ‘B’ which satisfies (B*number of subframes/slots in a radio frame+A) mod T=(UE_ID mod N); N is signaled by gNB in SI or RRC message; T is the length of the DRX cycle or LP WUS monitoring cycle.

Note that the gNB may determine the LP WUS-Os monitored by the UE as above and transmit the LP WUS in the LP WUS-O when it needs to page the UE or when it needs to indicate to the UE to wakeup/monitor a PO.

At step 1340, the UE receives an LP WUS in the monitored LP WUS-O. The LP WUS or LP WUS information/payload received in the monitored LP WUS-O indicates information to determine which configured grant occasion to monitor for paging.

In one embodiment, the LP WUS or LP WUS information/payload received in the monitored LP WUS-O may include an index of a configured grant occasion to monitor. The LP WUS or LP WUS information/payload received in the monitored LP WUS-O may include only one index of the configured grant occasion. This index is common for all UEs monitoring the LP WUS-O. In this case, if the LP WUS or LP WUS information/payload received in the monitored LP WUS-O indicates to monitor paging, the UE monitors the configured grant occasion indicated by the index of the configured grant occasion received in the LP WUS or LP WUS information/payload. The UE may use the MR to monitor the indicated configured grant occasion. The UE may wakeup the MR to monitor the indicated configured grant occasion. The LP WUS or LP WUS information/payload received in the monitored LP WUS-O may include an index of a configured grant occasion per subgroup (e.g., a paging subgroup/LP WUS subgroup). The LP WUS-O may indicate whether to monitor paging on a per subgroup basis. A subgroup identity can be signaled to the UE by the network (e.g., a gNB or AMF or CN) or the subgroup identity can be determined by the UE based on the UE's UE identity. For each subgroup for which paging monitoring is indicated, the LP WUS-O may indicate the index of the configured grant occasion to monitor. A maximum number of subgroups for which the LP WUS-O may indicate whether to monitor paging or not can be signaled by the network (e.g., in SI or an RRC message). In this case, if the LP WUS or LP WUS information/payload received in the monitored LP WUS-O indicates to monitor paging for the UE's subgroup, the UE monitors the configured grant occasion indicated by the index of the configured grant occasion corresponding to the UE's subgroup, received in the LP WUS or LP WUS information/payload. The UE may use the MR to monitor the indicated configured grant occasion. The UE may wakeup the MR to monitor the indicated configured grant occasion. The LP WUS or LP WUS information/payload received in the monitored LP WUS-O may include an index of a configured grant occasion for a specific purpose of paging e.g., for an MBS paging or an SI update or emergency notifications or paging for a specific RAN or network slice(s). For each purpose for which the paging monitoring (or monitoring a paging occasion) is indicated, the LP WUS-O may indicate the index of the configured grant occasion to monitor. In this case, if the LP WUS or LP WUS information/payload received in the monitored LP WUS-O indicates to monitor paging for an MBS paging and the UE is interested in the MBS paging, the UE monitors the configured grant occasion indicated by the index of the configured grant occasion corresponding to the MBS paging, received in the LP WUS or LP WUS information/payload. The UE may use the MR to monitor the indicated configured grant occasion. The UE may wakeup the MR to monitor the indicated configured grant occasion. If the LP WUS or LP WUS information/payload received in the monitored LP WUS-O indicates to monitor paging for an SI update/emergency notification and UE is interested in the SI update/emergency notification, the UE monitors the configured grant occasion indicated by the index of the configured grant occasion corresponding to the SI update/emergency notification, received in the LP WUS or LP WUS information/payload. The UE may use the MR to monitor the indicated configured grant occasion. The UE may wakeup the MR to monitor the indicated configured grant occasion. If the LP WUS or LP WUS information/payload received in the monitored LP WUS-O indicates to monitor paging for a specific RAN or network slice(s) and the UE belongs to or is interested in the specific RAN or network slice(s), the UE monitors the configured grant occasion indicated by the index of the configured grant occasion corresponding to the RAN or network slice(s), received in the LP WUS or LP WUS information/payload. The UE may use the MR to monitor the indicated configured grant occasion. The UE may wakeup the MR to monitor the indicated configured grant occasion.

In another embodiment, the LP WUS or LP WUS information/payload received in the monitored LP WUS-O may include a number (K) of configured grant occasions for paging. Based on current paging load and paging capacity of each paging message, the gNB may determine the number of configured grant occasions in which it needs to page. The gNB pages in the configured grant occasion with index 0 to K-1. In an alternate embodiment K can be signaled by the network in SI or an RRC message. K can be common for all UEs monitoring the LP WUS-O. In this case, if the LP WUS or LP WUS information/payload received in the monitored LP WUS-O indicates to monitor paging, the UE monitors the configured grant occasion with the index ‘i’ where i=UE_ID mod K. The UE may use the MR to monitor the configured grant occasion. The UE may wakeup the MR to monitor the configured grant occasion. K can be signaled per subgroup (e.g., a paging subgroup/LP WUS subgroup). In this case, if the LP WUS or LP WUS information/payload received in the monitored LP WUS-O indicates to monitor paging, the UE monitors the configured grant occasion with the index ‘i’ where i=UE_ID mod K, where K is number of configured grant occasions for paging for UE's subgroup. The UE may use the MR to monitor the configured grant occasion. The UE may wakeup the MR to monitor the configured grant occasion.

In another embodiment, the LP WUS or LP WUS information/payload received in the monitored LP WUS-O may include a number (K) of configured grant occasions for paging. In an alternate embodiment K can be signaled by the network in SI or an RRC message. The LP WUS or LP WUS information/payload indicates a starting configured grant occasion number (j). Based on a current paging load and paging capacity of each paging message, the gNB may determine the number of POs in which it needs to page. The gNB pages in the configured grant occasions with index j to j+K-1. The UE monitors the configured grant occasion with index ‘i’ where i=j+UE_ID mod K. The UE may use the MR to monitor the configured grant occasion. The UE may wakeup the MR to monitor the configured grant occasion. K and J can be common for all UEs or can be per subgroup.

At step 1350, the UE determines the configured grant occasion for paging based on the information received in the LP WUS or LP WUS payload.

At step 1360, the UE monitors the configured grant occasion indicated by the determined configured grant occasion index. The UE receives and decodes a PDSCH TB (or TB) in the determined configured grant occasion and receives the paging message. The configured grant occasion indicated by the determined configured grant occasion index/number is determined as follows:

The UE determines the configured grant occasions for paging occurring after the monitored LP WUS occasion, based on a configuration of configured grant occasions for paging. The configured grant occasions for paging which overlap with UL symbols, where the UL symbols are determined based on the TDD configuration, are considered invalid. In an alternate embodiment, the configured grant occasions for paging which overlap with UL symbols and special symbols where the UL and special symbols are determined based on the TDD configuration, are considered invalid. TDD configuration indicated DL symbols, UL symbols and special symbols. Special symbols can be dynamically configured as DL or UL symbols. Note that this step is performed for a TDD cell. In the case of an FDD cell, this step may be skipped.

In one embodiment, the valid configured grant occasions for paging are sequentially numbered/indexed (e.g., from zero or one) starting from the first configured grant occasion for paging after the LP WUS occasion. In another embodiment, the valid configured grant occasions for paging are sequentially numbered/indexed (e.g., from zero or one) starting from the first configured grant occasions for paging occurring after an ‘offset’ from the end of the LP WUS occasion. The ‘offset’ can be signaled by the network (e.g., a gNB) in system information or an RRC message or in the LP WUS or LP WUS information/payload. In one embodiment, the valid configured grant occasions for paging are sequentially numbered/indexed (e.g., from zero or one) starting from the first configured grant occasions for paging occurring after the radio frame or subframe or slot in which the UE monitored the LP WUS occasion. In another embodiment, the valid configured grant occasions for paging are sequentially numbered/indexed (e.g., from zero or one) starting from the first configured grant occasions for paging occurring after an ‘offset’ from the end of the radio frame or subframe or slot in which the UE monitored the LP WUS occasion. The ‘offset’ can be signaled by the network (e.g., a gNB) in system information or an RRC message or in the LP WUS or LP WUS information/payload. In another embodiment, the valid configured grant occasions for paging are sequentially numbered/indexed (e.g., from zero or one) starting from the first configured grant occasions for paging in the radio frame/subframe/slot indicated by the network (e.g., a gNB) in the LP WUS or LP WUS payload or SI or RRC message. The radio frame can be indicated by the SFN. Alternately, radio frames/subframes/slots after the LP WUS occasion can be sequentially indexed and this index of radio frame/subframe/slot can be indicated.

In one embodiment, the LP WUS/LP WUS-O as described regarding FIG. 13 can be a PEI/PEI-O. In another embodiment the LP WUS/LP WUS-O as described regarding FIG. 13 can be a PDCCH addressed to a P-RNTI/PO.

Although FIG. 13 illustrates one example UE operation for paging reception 1300, various changes may be made to FIG. 13. For example, while shown as a series of steps, various steps in FIG. 13 could overlap, occur in parallel, occur in a different order, occur any number of times, be omitted, or replaced by other steps.

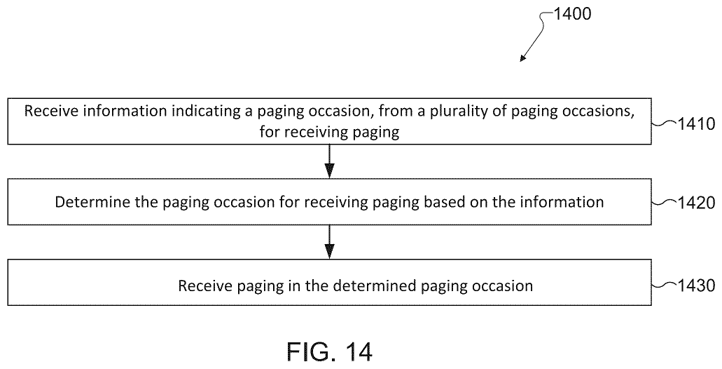

FIG. 14 illustrates an example method for paging reception 1400 according to embodiments of the present disclosure. An embodiment of the operation illustrated in FIG. 14 is for illustration only. One or more of the components illustrated in FIG. 14 may be implemented in specialized circuitry configured to perform the noted functions or one or more of the components may be implemented by one or more processors executing instructions to perform the noted functions. Other embodiments for a method for paging reception could be used without departing from the scope of this disclosure. In an embodiment, UE may indicate/signal (e.g. in RRC message) to gNB its capability to support the operation illustrated in FIG. 14.

In the example of FIG. 14, the method begins at step 1410. At step 1410, a UE, such as UE 116 of FIG. 1, receives information indicating a paging occasion, from a plurality of paging occasions, for receiving paging. At step 1420, the UE determines the paging occasion for receiving paging based on the information. Finally, at step 1430, the UE receives paging in the determined paging occasion.

Although FIG. 14 illustrates one example method for paging reception 1400, various changes may be made to FIG. 14. For example, while shown as a series of steps, various steps in FIG. 14 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps. The operation defined by various embodiments may be performed by UE and/or gNB in initial downlink bandwidth part and/or active downlink bandwidth part.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A user equipment (UE) comprising:
a transceiver configured to receive information indicating a paging occasion, from a plurality of paging occasions, for receiving paging; and
a processor operably coupled to the transceiver, the processor configured to determine the paging occasion for receiving paging based on the information,
wherein the transceiver is further configured to monitor the determined paging occasion for receiving paging.

2. The UE of claim 1, wherein:
the information indicating the paging occasion for receiving paging is a paging occasion index; and
the processor is further configured to:
determine the paging occasion for receiving paging based on the paging occasion index, and
monitor the determined paging occasion.

3. The UE of claim 1, wherein:
the information indicating the paging occasion for receiving paging is a paging occasion index for a paging subgroup associated with the UE; and
the processor is further configured to:
determine the paging occasion for receiving paging based on the paging occasion index, and
monitor the determined paging occasion.

4. The UE of claim 1, wherein:
the information indicating the paging occasion for receiving paging is a number (K) of paging occasions for receiving paging;
the UE is associated with a UE identity (UE_ID); and
the processor is further configured to:
determine a paging occasion index (i), where i=UE_ID mod K;
determine the paging occasion based on the paging occasion index; and
monitor the determined paging occasion.

5. The UE of claim 1, wherein:
the information indicating the paging occasion for receiving paging is a paging occasion index indicating a set of physical downlink control channel (PDCCH) monitoring occasions for paging from a plurality of sets of PDCCH monitoring occasions for paging; and
the processor is further configured:
to group, valid PDCCH monitoring occasions for paging occurring after an occasion in which the information indicating the paging occasion is received, sequentially into the plurality of sets of PDCCH monitoring occasions;
determine that the paging occasion for receiving paging is the set of PDCCH monitoring occasions indicated by the paging occasion index; and
monitor the determined paging occasion.

6. The UE of claim 1, wherein:
the information indicating the paging occasion is a starting physical downlink control channel (PDCCH) monitoring occasion number; and
the processor is further configured to:
sequentially number valid PDCCH monitoring occasions for paging occurring after an occasion in which the information indicating the paging occasion is received;
determine that the paging occasion is a set of consecutive PDCCH monitoring occasions starting from the PDCCH monitoring occasion for paging indicated by the starting PDCCH monitoring occasion number; and
monitor the determined paging occasion.

7. The UE of claim 1, wherein the information indicating the paging occasion is received in a low power wakeup signal (LP WUS) occasion.

8. A base station (BS) comprising:
a transceiver configured to transmit information indicating a paging occasion, from a plurality of paging occasions, for receiving paging; and
a processor operably coupled to the transceiver, the processor configured to determine a paging occasion for transmitting paging based on the information,
wherein the transceiver is further configured to transmit the paging in the paging occasion for receiving paging.

9. The BS of claim 8, wherein:
the information indicating the paging occasion for receiving paging is a paging occasion index; and
the processor is further configured to determine the paging occasion for transmitting paging based on the paging occasion index.

10. The BS of claim 8, wherein:
the information indicating the paging occasion for receiving paging is a paging occasion index for a paging subgroup associated with a UE; and
the processor is further configured to determine the paging occasion for receiving paging based on the paging occasion index.

11. The BS of claim 8, wherein:
the information indicating the paging occasion for receiving paging is a number (K) of paging occasions for receiving paging;
a UE is associated with a UE identity (UE_ID); and
the processor is further configured to:
determine a paging occasion index (i), where i=UE_ID mod K; and
determine the paging occasion based on the paging occasion index.

12. The BS of claim 8, wherein:
the information indicating the paging occasion for receiving paging is a paging occasion index indicating a set of physical downlink control channel (PDCCH) monitoring occasions for paging from a plurality of sets of PDCCH monitoring occasions for paging; and
the processor is further configured determine that the paging occasion for transmitting paging is the set of PDCCH monitoring occasions indicated by the paging occasion index.

13. The BS of claim 8, wherein the information indicating the paging occasion is transmitted in a low power wakeup signal (LP WUS) occasion.

14. A method of operating a user equipment (UE), the method comprising:
receiving information indicating a paging occasion, from a plurality of paging occasions, for receiving paging;
determining the paging occasion for receiving paging based on the information; and
monitoring the determined paging occasion for receiving paging.

15. The method of claim 14, wherein:
the information indicating the paging occasion for receiving paging is a paging occasion index;
determining the paging occasion for receiving paging is based on the paging occasion index; and
the method further comprises monitoring the determined paging occasion.

16. The method of claim 14, wherein:
the information indicating the paging occasion for receiving paging is a paging occasion index for a paging subgroup associated with the UE;
determining the paging occasion for receiving paging is based on the paging occasion index; and
the method further comprises monitoring the determined paging occasion.

17. The method of claim 14, wherein:
the information indicating the paging occasion for receiving paging is a number (K) of paging occasions for receiving paging;
the UE is associated with a UE identity (UE_ID); and
the method further comprises:
determining a paging occasion index (i), where i=UE_ID mod K, wherein the paging occasion is determined based on the paging occasion index, and
monitoring the determined paging occasion.

18. The method of claim 14, wherein:
the information indicating the paging occasion for receiving paging is a paging occasion index indicating a set of physical downlink control channel (PDCCH) monitoring occasions for paging from a plurality of sets of PDCCH monitoring occasions for paging; and
the method further comprises:
grouping valid PDCCH monitoring occasions for paging occurring after an occasion in which the information indicating the paging occasion is received, sequentially into the plurality of sets of PDCCH monitoring occasions, wherein the paging occasion for receiving paging is the set of PDCCH monitoring occasions indicated by the paging occasion index, and
monitoring the determined paging occasion.

19. The method of claim 14, wherein:
the information indicating the paging occasion is a starting physical downlink control channel (PDCCH) monitoring occasion number; and
the method further comprises:
sequentially numbering valid PDCCH monitoring occasions for paging occurring after an occasion in which the information indicating the paging occasion is received, wherein the paging occasion is a set of consecutive PDCCH monitoring occasions starting from the PDCCH monitoring occasion for paging indicated by the starting PDCCH monitoring occasion number, and
monitoring the determined paging occasion.

20. The method of claim 14, wherein the information indicating the paging occasion is received in a low power wakeup signal (LP WUS) occasion.
